(19) United States
(12) Patent Application Publication
(10) Pub. No.: US 2012/0029745 A1
(43) Pub. Date: Feb. 2, 2012

(54) Method of Controlling Energy Buffer Drive

(76) Inventor: Takayuki MIYAO, Matsukaze-cho (JP)

(21) Appl. No.: 13/017,840

(22) Filed: Jan. 31, 2011

(30) Foreign Application Priority Data
Feb. 1, 2010 (JP) 2010-019904

(51) Int. Cl. B60W 20/00; B60W 10/101; B60W 10/06

(52) U.S. Cl. 701/22; 701/54; 180/65.265; 903/902

(57) ABSTRACT

An energy buffer drive apparatus alternates between a state wherein a vehicle is caused to travel while rotational energy of a heat engine is intermittently stored in a flywheel, and a state wherein the vehicle is caused to travel using only the stored energy. In a process where the flywheel speed is reduced by the vehicle traveling using the rotational energy of the flywheel alone, the point in time when the heat engine again begins to supplement rotational energy to the flywheel is determined from (1) a speed ratio e=N2/N1 of the revolution speed N1 of the input shaft and the revolution speed N2 of the output shaft in the continuously variable transmission always being smaller than the maximum allowed speed ratio, and (2) the output power of the heat engine exceeding the demanded power for a power train when the heat engine starts supplying energy once more.

### BACKGROUND OF THE INVENTION

1. Field of the Invention

The present invention relates to a method of controlling an energy buffer drive in a drive line having a flywheel that interlocks with an input shaft of a continuously variable transmission, and adapted to cause a vehicle to travel while alternately performing an action of drawing a necessary portion of energy from a heat engine to the output shaft of the continuously variable transmission as the heat engine resupplies the input shaft and the flywheel with output power, and an action of drawing a necessary portion of energy to the output shaft of the continuously variable transmission exclusively from rotational energy that was resupplied to the flywheel.

In particular, the present invention relates to the determining of a point in time for the heat engine to again begin to supply rotational energy to the flywheel in the course of deceleration of the revolution speed of the flywheel due to the vehicle being driven exclusively with the rotational energy of the flywheel.

2. Description of the Related Art

Conventionally, an energy buffer drive system of such description has been known in Miyao (JP2006-290330). The functions in Miyao (JP2006-290330) comprise alternately performing a function of causing a vehicle to travel while intermittently operating the engine in a good specific fuel consumption range and briefly accumulating from the engine the intermittent output energy thereof in a mechanical manner, in the form of rotational energy to a flywheel; and a function of causing a vehicle to travel exclusively with the rotational energy accumulated in the flywheel.

This method of causing a vehicle to travel involves signaling of demanded power for the output shaft of the continuously variable transmission, and drawing power from the engine or flywheel according to the signaled demanded power.

In this case, under circumstances in which power is being drawn exclusively from rotational energy of the flywheel with the engine at a stop, the rotational energy of the flywheel gradually dissipates as the power is drawn therefrom, and the revolution speed of the flywheel decelerates.

As the flywheel decelerates in this manner, at some point in time, the flywheel must be resupplied with power from the engine.

Specifically, Miyao (JP2006-290330) describes control adapted to determine a “flywheel lower limit revolution speed” which represents the point in time that the flywheel has decelerated to the point that the engine should again resupply power to the flywheel.

This flywheel lower limit revolution speed is determined as described below.

When power is drawn exclusively from the flywheel to the output shaft via the continuously variable transmission, thereby causing the flywheel to decelerate to the aforementioned lower limit revolution speed, the revolution speed of the engine at the point in time that the engine again begins to resupply power to the flywheel must be a revolution speed synchronous with the flywheel lower limit revolution speed.

Furthermore, a control is carried out such that, at the point in time when the flywheel begins to be resupplied with power from the engine, the value of the engine power produced in the output shaft from the engine via the continuously variable transmission is a value slightly greater than the value of the demanded power that was signaled in the manner described above.

The reason is that the power for accelerating the flywheel is equal to the engine power that appears on the output shaft from the engine via the continuously variable transmission, minus the aforementioned demanded power to the output shaft.

Stated the opposite way, at the point in time when the flywheel begins to be resupplied with power from the engine, if the engine power that appears on the output shaft from the engine via the continuously variable transmission happens to be less than the aforementioned demanded power to the output shaft, some of the rotational energy of the flywheel will be consumed to make up for the deficit, causing the flywheel to decelerate further.

Where control is carried out in above manner, the flywheel lower limit revolution speed declines in a substantially proportional relationship to a decline in demanded power.

Specifically, with demanded power (which is proportional to the amount the accelerator pedal is depressed) at a low level, when the flywheel reaches the aforementioned lower limit revolution speed, the revolution speed of the engine as the engine begins to resupply power to the flywheel will lie to the low-speed rotation side of the fuel economy curve of the engine.

As discussed above, when the flywheel reaches the aforementioned lower limit revolution speed and the demanded power dictated by the accelerator pedal is at a low setting, then if power is supplied once more to the flywheel with the engine at low speed while the engine is kept operating within the range of optimal specific fuel consumption, the speed ratio of the continuously variable transmission becomes extremely large, and in some instances the maximum speed ratio may reach about 3.0.

The speed ratio e referred to here is the ratio e=N2/N1 of the input shaft revolution speed N1 to the output shaft revolution speed N2 in the continuously variable transmission.

In practical terms, issues relating to efficiency of power transmission, etc., necessitate a maximum speed ratio e of at most about 1.5 for a single continuously variable transmission.

Consequently, when a control is carried out such that the engine is constantly kept in operation at optimal specific fuel consumption circumstances, as taught in Miyao(JP 2006-290330), it will be necessary to provide an additional subtransmission disposed in series before or after the continuously variable transmission in order to extend the useable shift range.

A drive line with a continuously variable transmission and subtransmission serially disposed in this manner will have an overall heavier drive line weight, the drive line will occupy a larger volume of space, and shift control will be more complicated.

### SUMMARY OF THE INVENTION

It is accordingly an object of the present invention to provide a method of controlling an energy buffer drive in a system with a single continuously variable transmission interposed in the drive line leading from a flywheel to the driving wheels, whereby the need for an additional subtransmission in the drive line is obviated, and whereby the drive line may be operated in ideal fashion on the intended control line of the engine.

### Feature of the Present Invention

The energy buffer drive apparatus employed in the method of controlling an energy buffer drive of the present invention is described below.

A heat engine (1) interlocks with a flywheel (3) and an input shaft (4a), and the input shaft interlocks with driving wheels (6B) of a vehicle via a continuously variable transmission (400, 401, 402) and an output shaft (6).

The heat engine (1) has a control line Fec describing a relationship whereby output power rises in tandem with a rise in revolution speed in the heat engine, and the heat engine operates on the control line according to control of supplied fuel.

Driving of the vehicle follows a relationship whereby demanded power P1i to the power transmission line extending from the input shaft (4a) to the output shaft (6) is signaled by the degree to which an accelerator pedal is depressed when the accelerator pedal is depressed.

A relationship between output power Pe and revolution speed Ne on the control line Fec in the heat engine is stored in memory in a control device (7, 700).

Control in this energy buffer drive apparatus takes place as follows.

The control device (7, 700) controls in alternating fashion the actions described in (a) or (b):
(a) an action whereby rotational energy of the flywheel (3) alone is the power supply source to the input shaft (4a), and
(b) an action whereby the heat engine (1) is the power supply source to the input shaft (4a) while operating on the control line (Fec) and accelerating rotation of the flywheel (3).

The control device, in a control according to (a) and (b) above,
computes, using the relationship T1i=P1i/ω1, signaled torque T1i in the input shaft from the demanded power P1i and rotational angular velocity ω1 at a current time in the input shaft (4a).

Additionally, actual torque T1 equivalent to the signaled torque T1i is generated in the input shaft through torque control accomplished by shifting of the continuously variable transmission.

Further, the shifting in the continuously variable transmission converts the resulting actual torque T1 to a torque T2 of the output shaft (6), and the converted torque T2 drives the driving wheels (6B).

The revolution speed N1 of the input shaft continuously decline during control of the control device carrying out the action of (a).

In such control, the control device by way of a first assessment, calculates one lower limit revolution speed N1ce from the relationship N1ce=N2/ec, where N2 is revolution speed in the output shaft at the current point in time and ec is the maximum permissible speed ratio of the speed ratio e=N2/N1 in the continuously variable transmission.

Further, the control device, by way of a second assessment, on the basis of the relationship of revolution speed Ne and output power Pe in the heat engine on the control line Fec, calculates a revolution speed Ne=Nec of the heat engine under circumstances in which output power Pe in the heat engine equals the value of the demanded power P1i at the current point in time or a value equal to the demanded power P1i at the current point in time plus a prescribed power ΔP1i. the control device further calculates revolution speed N1ca in the input shaft on the assumption that the input shaft is being driven by the heat engine at the calculated revolution speed Nec, and computes N1ca as another lower limit revolution speed N1ca in the input shaft.

Further, the control device designates the larger of the values of N1ce and N1ca as the true lower limit revolution speed N1c, and when the revolution speed N1 continues to decline and the revolution speed N1 reaches the true lower limit revolution speed N1c, restarts the heat engine, and begins to resupply power of the heat engine (1) to the flywheel and to the input shaft.

In the event that, due the vehicle being caused to travel exclusively with rotational energy of the flywheel (3), the rotational energy of the flywheel (3) is consumed and the revolution speed of the flywheel (3) as well as the input shaft (4a) accordingly decelerates, the control according to the present invention will resupply power from the heat engine (1) to the flywheel (3) and to the input shaft (4a) under circumstances in which both of the following conditions are met:
(1) the speed ratio e of the continuously variable transmission (400) according to the first assessment is always equal to or less than the maximum permissible speed ratio ec; and
(2) the flywheel (3) can be made to accelerate at the time that power begins to be resupplied from the heat engine (1) to the flywheel (3) and the input shaft (4a) according to the second assessment.

As a result, the method for controlling an energy buffer drive according to the present invention enables usage while allowing the speed ratio e of the continuously variable transmission (400) to be consistently kept at or below the maximum permissible speed ratio ec which is associated with excellent efficiency of power transmission, and while meeting the aforementioned condition (2) during power resupply as described above.

The need to provide the continuously variable transmission (400) with a subtransmission is thus obviated, making it possible to simplify the entire drive line, avoid complicated control in the drive line, and avoid increasing the weight of the drive line.

### Best mode of Embodiments of the Present Invention

The energy buffer drive apparatus employed in the method of controlling an energy buffer drive of the present invention is described as follows.

A heat engine (1) interlocks with a flywheel (3) and an input shaft (4a), and the input shaft interlocks to driving wheels (6B) of a vehicle via a continuously variable transmission (402) and an output shaft (6).

In the continuously variable transmission (402), of three shafts in a differential gear (41), one shaft interlocks with the input shaft (4a), another shaft interlocks with a generator-motor (40), and a final remaining shaft interlocks with the output shaft (6). As a general rule (in principle), all of the electrical power generated in the generator-motor (40) is transmitted to a motor-generator (5), and the motor-generator (5) interlocks with the output shaft (6).

The heat engine (1) has a control line Fec describing a relationship whereby output power rises in tandem with a rise in revolution speed; and the heat engine operates on the control line through control of supplied fuel.

The vehicle is driven according to a relationship whereby demanded power P1i for the power transmission line section extending from the input shaft (4a) to the output shaft (6) is signaled by the degree to which an accelerator pedal is depressed when the accelerator pedal is depressed.

A relationship between output power Pe and revolution speed Ne on the control line Fec in the heat engine is stored in memory in a control device (7).

Control in this energy buffer drive apparatus takes place as follows.

The control device (7) controls in alternating fashion the actions of (a) or (b):
(a) an action whereby rotational energy of the flywheel (3) alone is the power supply source to the input shaft (4a); and
(b) an action whereby the heat engine (1) is the power supply source to the input shaft (4a) while operating on the control line Fec and accelerating rotation of the flywheel (3).

In control according to (a) and (b) above, the control device (7) using the relationship T1i=P1i/ω1, computes signaled torque T1i in the input shaft (4a) from the demanded power P1i and rotational angular velocity ω1 at the current time in the input shaft (4a).

Additionally, actual torque T1 equivalent to the signaled torque Iii is generated in the input shaft (4a) through torque control accomplished in the generator-motor (40). Further, through the aforementioned shifting in the continuously variable transmission (400), the actual torque T1 so generated undergoes torque conversion to torque T2 of the output shaft (6), and the converted torque T2 drives the driving wheels (6B) in FIG. 1.

The revolution speed N1 of the input shaft (4a) continuously decline during control of the control device (7) carrying out the action of (a). In such control, the control device (7), by way of a first assessment, calculates one lower limit revolution speed Nice from the relationship N1ce=N2/ec, where N2 is revolution speed in the output shaft (6) at the current point in time and ec is the maximum permissible speed ratio of the speed ratio e=N2/N1 in the continuously variable transmission (400).

Further, the control device (7), by way of a second assessment, on the basis of the relationship of revolution speed Ne and output power Pe in the heat engine (1) on the control line Fec, calculates a revolution speed Ne=Nec of the heat engine (1) under circumstances in which output power Pe in the heat engine (1) equals the value of the demanded power P1i at the current point in time or a value equal to the demanded power P1i at the current point in time plus a prescribed power ΔP1i. The control device (7) further calculates revolution speed N1ca in the input shaft (4a) on the assumption that the input shaft (4a) is being driven by the heat engine (1) at the calculated revolution speed Nec, and computes N1ca as another lower limit revolution speed N1ca in the input shaft (4a).

Further, the control device (7) designates the larger of the values of N1ce and N1ca as the true lower limit revolution speed N1c. The control device (7), when the revolution speed N1 continues to decline and the revolution speed N1 reaches the true lower limit revolution speed N1c, restarts the heat engine (1), and begins to resupply power of the heat engine (1) to the flywheel (3) and to the input shaft (4a).

### BRIEF DESCRIPTION OF THE DRAWINGS

FIG. 1 is a schematic diagram of an energy buffer drive apparatus capable of performing the method for controlling an energy buffer drive of the present invention;

FIG. 2 is a typical characteristics chart for an engine that is a main part of the apparatus represented in FIG. 1;

FIG. 3 is a graph indicating the relationship between the engine output power Pe (kW) and the consumed fuel mass per unit output power per unit time f(gr/kW·h) that satisfied the fuel economy curve Fec represented in FIG. 2;

FIG. 4 represents the relationship of demanded power P1i to the input shaft (i.e., engine output power Pe) (kW) and the engine revolution speed Ne (rpm) as obtained from the fuel economy curve Fec represented in FIG. 2;

FIG. 5 is a schematic diagram of another energy buffer drive apparatus capable of performing the method for controlling an energy buffer drive of the present invention, the diagram of the energy buffer drive apparatus including, in particular, a specific example of a continuously variable transmission that is a main structural element;

FIG. 6 is a schematic diagram of yet another energy buffer drive apparatus capable of performing the method for controlling an energy buffer drive of the present invention, the diagram of the energy buffer drive apparatus including, in particular, another specific example of a continuously variable transmission that is a main structural element; and

FIG. 7 is a schematic diagram representing in detail a differential gear that is an element of the apparatus of FIG. 6.

### DETAILED DESCRIPTION OF THE PREFERRED EMBODIMENTS

### [Configuration of Energy Buffer Drive Device]

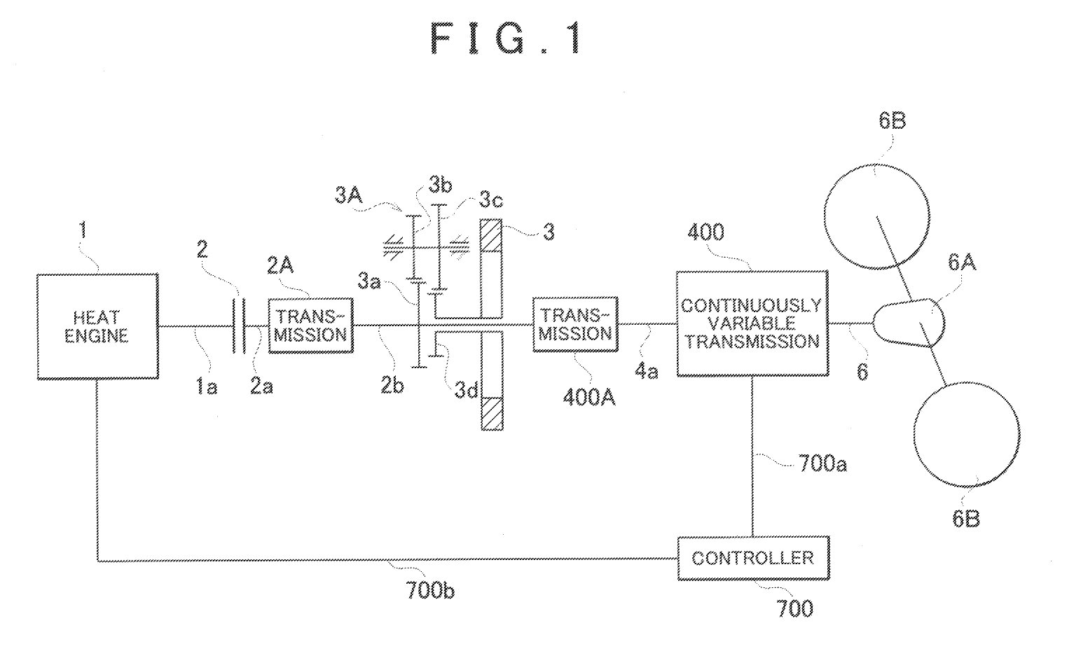

FIG. 1 shows an example of an energy buffer drive device used in the energy buffer drive control according to the present invention. In FIG. 1, a gasoline engine 1 (herein referred to simply as “engine 1”) is used as one example of a heat engine that interlocks with a drive shaft 2b via a drive shaft 1a, a clutch 2, a drive shaft 2a, and a transmission 2A.

The term “interlock” refers to the forming of a path for transmitting power via a gear, drive shaft, belt, crank, or the like. Consequently, “interlock” in the simplest sense refers to a power transmission pathway for direct connection of the flow of power via a single drive shaft.

The drive shaft 2b interlocks with a flywheel 3 via a speed increasing gear 3A composed of gears 3a, 3b, 3c and 3d. The drive shaft 2b also interlocks with the driving wheels 6B, 6B of the vehicle via a transmission 400A, an input shaft 4a, a continuously variable transmission 400, an output shaft 6, and a final reduction gear 6A.

The gears 3b and 3c have a structure in which they are in direct connection to the same drive shaft and rotate in unison.

Reference number 700 denotes a control device for controlling the speed ratio of the continuously variable transmission 400, as well as controlling the engine 1, the clutch 2, and other components via a control line 700a or 700b, and for sensing revolution speed and rotational angular velocity of each of the rotating drive shafts, or other components.

The control lines 700a and 700b are represented by single lines including an electrical power line and a plurality of signal lines.

In FIG. 1, the transmission 2A may be replaced by a drive shaft in which the drive shaft 2a and the drive shaft 2b are directly connected. Also, the transmission 400A may be replaced by a drive shaft in which the drive shaft 2b and the input shaft 4a are directly connected. Further, the speed increasing gear 3A may be replaced by a direction connection of the flywheel 3 and the drive shaft 2b. The transmissions 2A and 400A and the speed increasing gear 3A are provided for the purposes of general discussion.

This concludes the discussion of the mechanism of the energy buffer drive device according to FIG. 1.

### [Characteristics of the Engine 1]

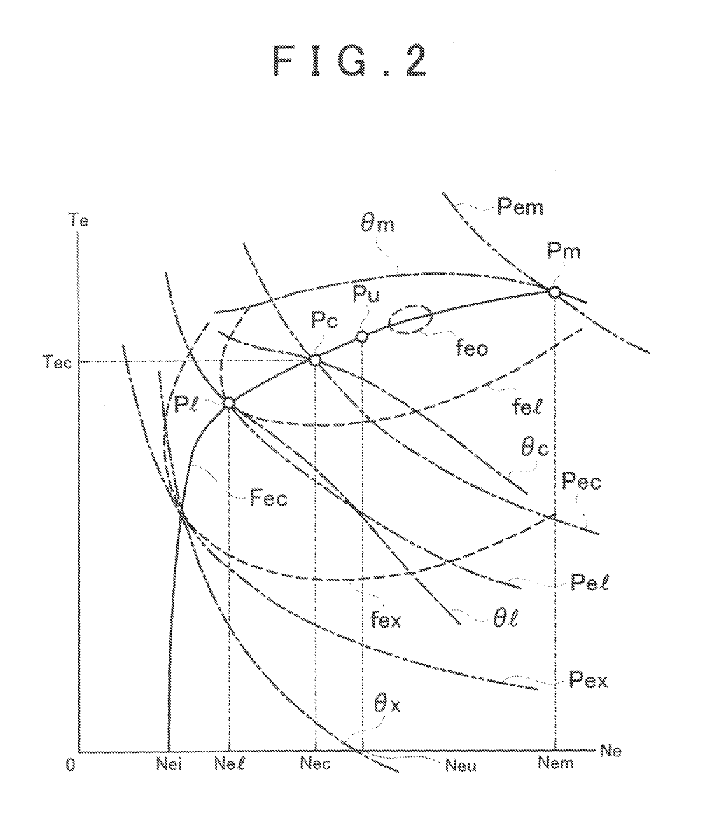

The typical characteristics of the engine 1 in FIG. 1 are described using FIG. 2.

In FIG. 2, the horizontal axis shows the revolution speed Ne (rpm) of the engine 1, and the vertical axis shows the output torque Te (N·m) of the engine 1.

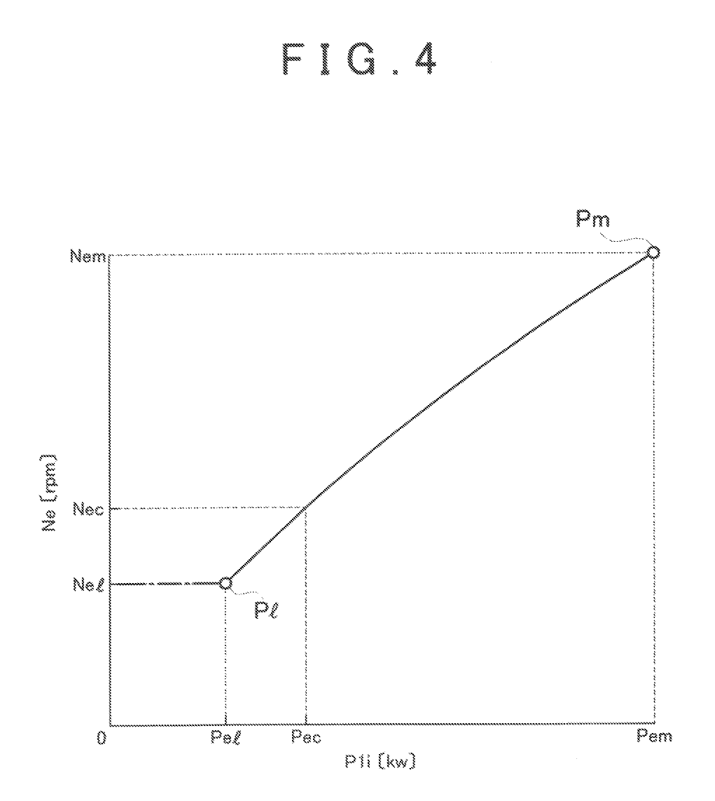

The fuel economy curve Fec in FIG. 2 shows the characteristics that afford optimal fuel consumption (gr) of the engine 1 per unit time, for each of any output power (kW) levels at which the engine 1 operates at constant output power. The fuel economy curve Fec may be derived from actual measurements. The general characteristics of the fuel economy curve Fec, such as those shown by FIG. 4 in Japanese Laid-Open Patent Application 2001-298805 are widely known.

In FIG. 2, θm shows the maximum output torque characteristic curve in the engine 1 under circumstances of maximum throttle angle in the engine 1 and maximum rate of fuel feed to the engine 1. Constant characteristic curves observed at throttle angles θ equal to or less than the maximum throttle angle θm becoming successively smaller in the order θc, θl, θx.

In FIG. 2, the characteristic curves Pem, Pec, Pel, Pex respectively represented by double-dot and dash lines are characteristic curves for constant levels of output power of the engine 1; with regard to the magnitude of output power, starting from the maximum output power Pem, output power is progressively smaller in the order Pec, Pel, Pex.

Characteristic curves feo, fel, fex represented by dotted lines and associated with constant levels of specific fuel consumption (the amount of fuel used per unit output power per unit time) (gr/kW·h) are characteristic curves ordinarily indicating progressively poorer specific fuel consumption further away towards the outside from feo. These characteristic curves are used generally.

The gasoline engine characteristic curves shown in FIG. 2 are similar to the characteristic curves for a diesel engine, in relation to revolution speed, output torque, and fuel feed rate. Therefore, the gasoline engine in FIG. 1 could be a diesel engine instead. However, in the case of the gasoline engine 1 discussed above, adjustment of the fuel feed rate is accomplished through adjustment of the throttle angle θ, whereas in the case of a diesel engine, the fuel feed rate to the engine cylinders is adjusted directly.

This concludes the discussion of the general characteristics of the engine 1.

There now follows a description of the functions of the energy buffer drive device in FIG. 1.

### [Enabling Vehicle Ignition]

In the state prior to ignition and initial acceleration of the vehicle, the control device 700 sets the speed ratio e of the continuously variable transmission 400 to zero, and brings the load of the input shaft 4a to zero. The speed ratio e is the ratio e=N2/N1 of the revolution speed N1 of the input shaft 4a and the revolution speed N2 of the output shaft 6.

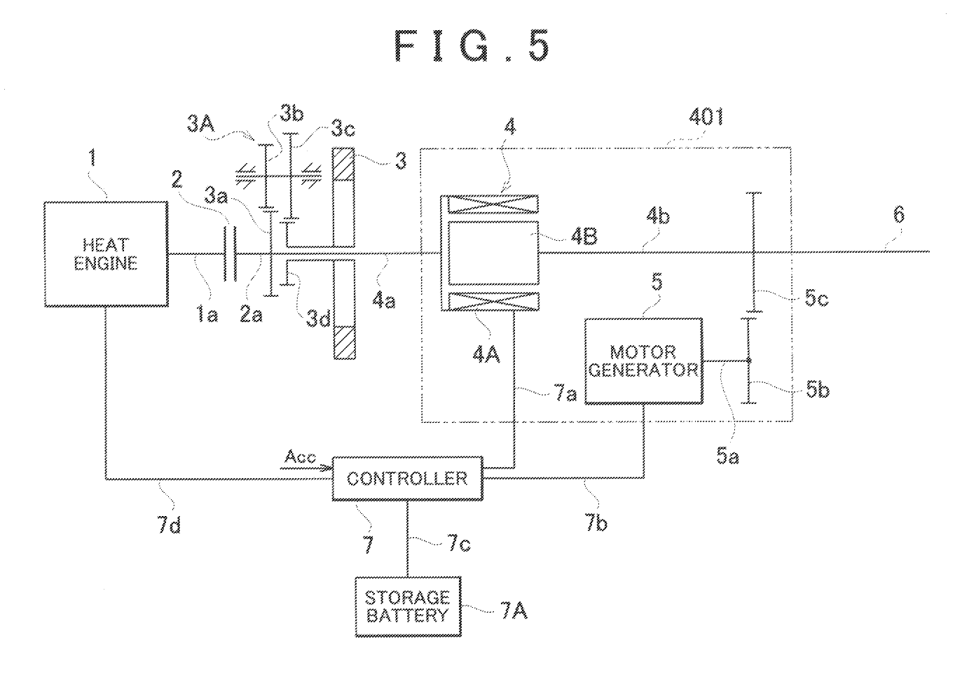

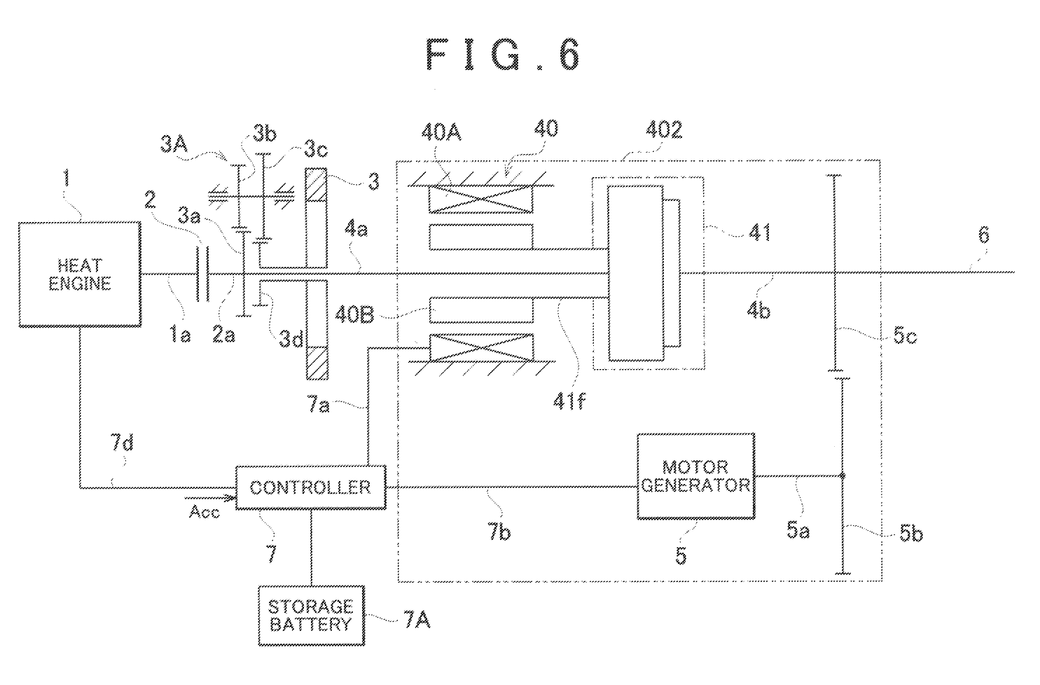

Any number of known methods may be used as the method for bringing the load of the input shaft 4a to zero; for example, an electromagnetic clutch or the like may be provided in the continuously variable transmission 400, or, when the vehicle is at a stop, releasing the clutch so that power of the input shaft 4a is not transmitted to the output shaft 6. One example will be described later in FIG. 5 and FIG. 6.

With the aforementioned speed ratio e at zero, when the ignition switch (or switch key) is turned on in order to initially accelerate the vehicle, during the interval that the side brake is being released and the shift lever is positioned to put the vehicle into forward or into reverse, the control device 700 drives the engine 1 in the idling state, and engages the clutch 2 during this interval as well.

The control device 700 controls the throttle angle e of the engine 1 while engaging the clutch 2 in this manner.

During the initial stage in which the clutch 2 is initially engaged, the engine 1 assumes the aforementioned idling state; and, as the clutch is engaged, the control device 700 increases the throttle angle θ of the engine 1.

The throttle angle θ is increased in a state such that the throttle angle e and revolution speed Ne of the engine 1 at that point in time are always coincident on the fuel economy curve Fec in FIG. 2.

In the case of acceleration of the flywheel 3 by the engine 1 via the drive shaft 1a, the clutch 2, the drive shaft 2a, the transmission 2A, the drive shaft 2b, and the speed increasing gear 3A, there exists the relationship below, where the component of the torque in the drive shaft 2b representing acceleration only of the flywheel 3 by the drive shaft 2b via the speed increasing gear 3A is denoted as Tfi; the speed increasing ratio in the speed increasing gear 3A is denoted as i1; and the torque of rotational acceleration of the flywheel 3 by the gear 3d is denoted as Tf:

Tfi=i1×Tf (1)

Also, the relationship of rotational acceleration of the flywheel 3 by torque Tf of the gear 3d is represented as:

Tf=If×(dωf/dt) (2)

where “If” is the moment of inertia of the flywheel 3, and (dωf/dt) is the rotational angular acceleration of the flywheel 3.
From formulas (1) and (2):

Tfi=If×i1×(dωf/dt) (3)

Specifically, with the load of the input shaft 4a at zero during ignition and initial acceleration of the vehicle, when the engine 1 drives the drive shaft 2b via the drive shaft 1a, the clutch 2, the drive shaft 2a, and the transmission 2A, torque Tfi represented by formula (3) arises in the drive shaft 2b and gives rise to rotational acceleration of the flywheel 3.

In the case described above, as may be appreciated from FIG. 1, the torque Tfi arising in the drive shaft 2b and the torque Te arising in the engine 1 have a constant torque ratio relationship via the drive shaft 1a, the clutch 2, the drive shaft 2a, and the transmission 2A. Specifically, if torque Tfi arises in the drive shaft 2b, torque Te proportional to the torque Tfi arises in the engine 1.

Where the engine 1 produces rotational acceleration of the flywheel 3 by increasing the throttle angle θ in this way, if at the current point in time the revolution speed Ne of the engine 1 is such that Ne=Nec in FIG. 2, the control device 700 performs control to bring the throttle angle e at that point in time to a state of coincidence such that θ=θc; and at that point in time the torque arising in the engine 1 assumes the value of Tec in FIG. 2.

In this way, the engine 1 operates on the fuel economy curve Fec, and at the point in time that the revolution speed of the flywheel 3 reaches a prescribed revolution speed, the engine 1 reaches, for example, point Pu on the fuel economy curve Fec, at which point in time the control device 700 will stop the fuel feed to the engine 1 and disengage the clutch 2.

The fact that the flywheel 3 has reached the prescribed revolution speed can be recognized through sensing of the revolution speed of any rotating component of the drive line, from the drive shaft 2a to the input shaft 4a via the transmission 2A, the drive shaft 2b, and the transmission 400A.

Also, one acceptable method for setting the flywheel 3 to the prescribed revolution speed for the purpose of enabling vehicle ignition as described above is to add a motor-generator to the drive shaft 2b; and with the clutch 2 released, to employ the motor-generator to accelerate the flywheel 3 to the prescribed revolution speed via the drive shaft 2b and the gears 3a, 3b, 3c, 3d.

This concludes the discussion of the function of enabling vehicle ignition.

[Description of Signaling for Driving of Vehicle through Depressing of Accelerator Pedal]

During vehicle operation, the supplied power necessary for causing the vehicle to travel is adjusted by depressing the accelerator pedal operated by the driver.

In this case, according the present invention, and as discussed later, there are two functions for use respectively (a) in the case that the vehicle is driven by rotational energy of the flywheel 3 alone; and (b) in the case that the engine 1 drives the vehicle through driving of the input shaft 4a concomitantly with rotational acceleration of the flywheel 3.

In the case of either function, the relationship of the amount the accelerator pedal is depressed and the supplied power needed to cause the vehicle to travel is as follows.

In the present embodiment, the amount of depressing of the accelerator pedal serves as an instruction value (herein also termed demanded power P1i) that indicates demand for generation of power P1 (kW) to the input shaft 4a.

“P1” is given as a designation in order to indicate terms relating to the input shaft, and also to differentiate those terms from terms relating to the output shaft, which are designated “P2,” as discussed further below.

Within a range of 0 (zero) to a prescribed instruction value of the instruction value, when the instruction value is equal to the prescribed value, the demanded power P1i to the input shaft 4a at that instruction value will correspond to the value of Pem in FIG. 2.

Pem represents the maximum power value on the fuel economy curve Fec of the engine 1.

Here, depressing of the accelerator pedal instructs input of demanded power P1i to the input shaft 4a; and because P1i is equal to Pem when the demanded power P1i is at the prescribed instruction value, this means that the demanded power P1i=Pem in this case is the maximum power able to be continuously output to the driving wheels 6B, 6B via the continuously variable transmission 400, the output shaft 6, and the final reduction gear 6A.

This is due to the fact that the engine 1 is the power source necessary for causing the vehicle to travel; the power Pe capable of being outputted by the engine 1 is such that 0<Pe≦Pem as noted previously; and the demanded power P1i must fall within the range at which the power source, namely, the engine 1, is able to continuously output.

However, it is possible for the amount of depressing of the accelerator pedal to be set to a value at or above the aforementioned prescribed instruction value. This is because by providing the additional motor-generator to the drive shaft 2b of FIG. 1, supplying power to the motor-generator from an electrical storage device (not shown), and carrying out the motor function of the motor-generator, electrical power can be resupplied from the electrical storage device in addition to the power from the motor.

When demanded power P1i to the input shaft 4a is signaled the above manner, the control device 700 senses the rotational angular velocity ω1 in the input shaft 4a.

Here, because the actual power P1 arising in the input shaft 4a is the product of actual torque T1 arising in the input shaft 4a and the rotational angular velocity ω1, the relationship is:

T1=P1/ω1 (4)

The demanded power P1i for the input shaft 4a as caused by depressing of the accelerator pedal means, resultantly, that depressing of the accelerator pedal signals torque T1i to the input shaft 4a.

The reason is that if in the discussion of formula (4) above, demanded power P1i to the input shaft 4a is substituted for actual power P1 arising in the input shaft 4a, and signaled torque T1i to the input shaft 4a is substituted for actual torque T1 arising in the input shaft 4a, the relationship is:

T1i=P1i/ω1 (4a)

The preceding discussion relates to signaling for driving of a vehicle through depressing the accelerator pedal.

### [(a) Causing Vehicle to Travel Using Rotational Energy of Flywheel 3 Alone]

Once enabling of vehicle ignition is completed, the revolution speed of the flywheel 3 has reached the prescribed revolution speed, and operation of the engine 1 has stopped, if the vehicle now initially accelerates, the system switches to a function of driving the vehicle with the rotational energy of the flywheel 3 alone.

In this case, the control device 700 computes a signaled torque T1i to be established in the input shaft 4a in accordance with formula (4a) as described above, and next controls the speed ratio e=N2/N1 of the continuously variable transmission 400 to produce actual torque T1 in the input shaft 4a.

While control of the speed ratio e in the continuously variable transmission 400 will differ depending on the type of continuously variable transmission, one known system in which the continuously variable transmission utilizes drive belt transmission between a drive pulley and a follower pulley is a system that involves control of the drive radius ratio of the drive pulley and a follower pulley. The system depicted in FIG. 5 and FIG. 6 described later involves controlling the speed ratio e through control of the amount of generated power.

Shift control of the speed ratio e involves reducing over time the revolution speed N1 of the input shaft 4a on the side of smaller moment of inertia in relation to the output shaft 6 which drives the large mass of the vehicle, giving rise to negative rotational angular velocity dω1/dt in the input shaft 4a. As a result, the negative rotational angular velocity dω1/dt decelerates the flywheel 3 via the transmission 400A and the gears 3a, 3b, 3c and 3d.

This progressive deceleration of the flywheel 3 occurs due to negative rotational angular velocity dωf/dt occurring in the flywheel 3 as well. This means that torque Tf for the flywheel 3 to drive the gear 3d is produced in accordance with formula (2).

The torque Tf arising in the flywheel 3 produces torque T1 in the input shaft 4a via the speed increasing gear 3A and the transmission 400A.

In this case, the relationship of the torque Tf arising in the flywheel 3 and the torque T1 arising in the input shaft 4a thereby is:

T1=(i1/i2)×Tf (5)

The following relationship also exists:

ωf=(i1/i2)×ω1 (6)

“i2” is the ratio (N1/Ni) of acceleration or deceleration in the transmission 400A, and “Ni” is the revolution speed of the drive shaft 2b.

Further, formulas (2), (5) and (6) give:

(dω1/dt)=Ti/[(i1/i2)×((i1/i2)×If) (7)

Specifically, the control device 700 substitutes the demanded power P1i signaled by depressing the accelerator pedal into formula (4a) and calculates a signaled torque T1i, then substitutes this signaled torque T1i for T1 (T1=T1i) in formula (7) and computes rotational angular velocity dω1/dt of the input shaft 4a.

Further, if the control device 700 controls the shift speed de/dt of the speed ratio e=N2/N1 in the continuously variable transmission 400 to equal the rotational angular velocity dω1/dt that was calculated from formula (7), actual torque T1 is produced in the input shaft 4a.

The reason is that if de/dt is controlled, in e=N2/N1, the input shaft revolution speed N1 on the low moment of inertia side, i.e., the input shaft rotational angular velocity ω1, varies over time in relation to the revolution speed N2 of the output shaft 6 which drives the large mass of the vehicle, so that dω1/dt can be controlled.

Production of actual torque T1 in the input shaft 4a in this manner means that power of P1=T1×ω1 is generated in the input shaft 4a in the manner described earlier.

Specifically, production of actual torque T1 in the input shaft 4a through shift control of the speed ratio e of the continuously variable transmission 400 means that “actual torque T1 equivalent to signaled torque T1i is generated in the input shaft 4a through torque control by shifting of the continuously variable transmission 400”.

Here, where efficiency of power transmission of the continuously variable transmission 400 is denoted as η, rotational angular velocity in the output shaft 6 is denoted as ω2, and torque in the output shaft 6 is denoted as T2, because T1×ω1×η=T2×ω2, there exists the relationship:

T2=(1/e)×η×T1 (8)

The speed ratio e=ω2/ω1.

Also, the speed ratio e in formula (8) represents the speed ratio e at the current point in time at which actual torque T1 is produced in the input shaft 4a through control of the speed ratio e by the control device 700.

Specifically, torque T2 of the output shaft 6 arising from the relationship of formula (8) through control of the speed ratio e drives the driving wheels 6B, 6B via the final reduction gear 6A.

In the course of driving of the driving wheels 6B, 6B with rotational energy of the flywheel 3 alone in the above manner, the rotational energy of the flywheel 3 is consumed and the revolution speed of the flywheel 3 decreases. Also, because the flywheel 3 and the input shaft 4a interlock at a constant speed ratio, when the flywheel 3 decelerates the input shaft 4a decelerates also. The vehicle travel action wherein the input shaft 4a decelerates in this manner continues until the revolution speed N1 of the input shaft 4a reaches a lower limit revolution speed N1c, discussed later.

This concludes the discussion of the function of causing the vehicle to travel using rotational energy of the flywheel 3 alone.

### [Determination of Lower Limit Revolution Speed in Input Shaft 4a (First Assessment)]

When the vehicle is initially accelerated by rotational energy of the flywheel 3 alone and the accelerator pedal is depressed, on the one hand, vehicle speed accelerates and the revolution speed N2 of the output shaft 6 increases, while on the other hand the revolution speed N1 of the input shaft 4a decelerates as described above.

This increase of N2 on the one hand and decrease of N1 on the other means that the speed ratio e=N2/N1 in the continuously variable transmission 400 increases.

Here, from the standpoint of efficiency of power transmission, which is an issue of current concern, there is imposed a maximum permissible speed ratio ec which is serviceable in the continuously variable transmission 400. Consequently, it is preferable for shift control of the continuously variable transmission 400 to be carried out such that the speed ratio e is always kept within the range e≦ec. As will be discussed later, the value of the maximum permissible speed ratio ec will differ depending on the specific type of continuously variable transmission.

Transformation of the range e=N2/N1≦ec of the aforementioned serviceable speed ratio e gives:

N1≧N2/ec (9)

Specifically, it is necessary for the revolution speed N1 of the input shaft 4a to be always controlled so as to fulfill the relationship of formula (9). Optionally, revolution speed N2 in formula (9) is the revolution speed of the output shaft 6 sensed at the point in time of control.

In the course of deceleration of the revolution speed N1 of the input shaft 4a due to running of the vehicle with the rotational energy of the flywheel 3 alone in this manner, where the lower limit revolution speed of the input shaft 4a in formula (9) is N1=N1ce, the relationship below follows from formula (9):

N1ce=N2/ec (9a)

In the course of deceleration of the revolution speed N1 of the input shaft 4a as described above, the control device 700 intermittently carries out a first assessment using formula (9a) as to whether the revolution speed N1 in the input shaft 4a has reached the lower limit revolution speed N1ce.

Specifically, at the point in time when the revolution speed N1 of the input shaft 4a reaches N1=N1ce, if the flywheel 3 is then resupplied with rotational power from the engine 1, the condition of formula (9) will always be met. The reason is that if the flywheel 3 is resupplied with rotational power of the engine 1, the revolution speed N1 of the input shaft 4a which interlocks with the flywheel 3 accelerates as well.

This concludes the discussion of the first assessment among the determinations of lower limit revolution speed in the input shaft 4a.

[Magnitude Comparison of Engine 1 Power and Demanded Power p1i at Intermittent Intervals During Decelerating Revolution Speed of Input Shaft 4a (Second Assessment)]

From the aforementioned first assessment alone it is not yet possible to determine whether to begin resupplying the flywheel 3 and the input shaft 4a with power Pe from the engine 1.

In the event that, as a result of the first assessment, the engine 1 begins to resupply power to the input shaft 4a and the flywheel 3, if at the point in time that power resupply begins the relationship of the output power Pe of the engine 1 and the demanded power P1i happens to be

P1i>Pe,

the flywheel 3 will not accelerate, but will instead continue to decelerate.

This means that if P1>Pe at the point in time that the engine 1 starts to supply power to the input shaft 4a, a power deficit of P1−Pe=ΔP occurs in the input shaft 4a.

When such a power deficit ΔP occurs, rotational energy of the flywheel 3 is consumed in an amount equivalent to the power deficit ΔP. Such consumption of rotational energy in the flywheel 3 causes deceleration of the flywheel 3, and also decelerates the revolution speed N1 of the input shaft 4a which interlocks with the flywheel 3.

Consequently, in the event that the revolution speed N1 of the input shaft 4a in interlocked fashion decreases as the flywheel 3 decelerates, then when the engine 1 is driven and the power of the engine 1 is once again supplied to the flywheel 3 and the input shaft 4a at the current point in time, it will be necessary to carry out a second assessment as to whether the relationship of the output power Pe of the engine 1 and the demanded power P1i at that point in time is

P1i≦Pe.

Specifically, the control device 700 intermittently carries out the second assessment in addition to the first assessment.

The second assessment involves, during each of a number of determination intervals carried out on an intermittent basis, engaging the clutch 2 and carrying out determination based on the assumption that the engine 1 has initiated driving of the flywheel 3 and the input shaft 4a.

Consequently, with the engine 1 driving the input shaft 4a under these hypothetical circumstances, a constant interlocked relationship exists between the revolution speed Ne in the engine 1 and the revolution speed N1 in the input shaft 4a; and, moreover, the relationship between the demanded power P1i to the input shaft 4a and the output power Pe of the engine 1 must be

P1i≦Pe.

Here, the characteristics of the fuel economy curve

Fec of the engine 1 used in the second assessment are now described.

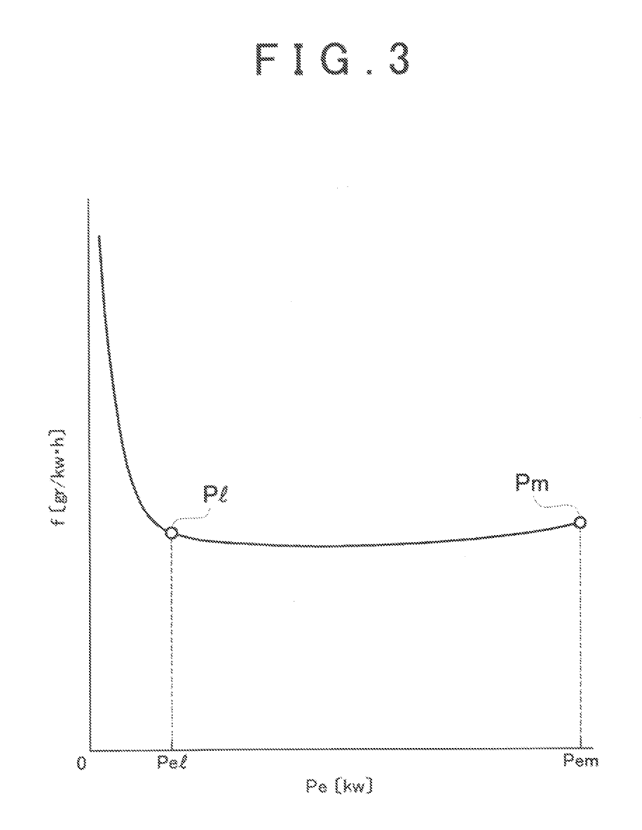

On the fuel economy curve Fec in FIG. 2, the engine 1 output power Pe and the consumed fuel mass per unit power per unit time (hereinafter termed the specific fuel consumption) f(gr/kW·h) is typically as shown in FIG. 3.

The characteristic curve of specific fuel consumption f in FIG. 3 indicates excellent values in the range Pel≦Pe≦Pem, with specific fuel consumption becoming suddenly worse at Pe<Pel.

For reasons such as those given above, according to the present embodiment, with the engine 1 resupplying output power Pe to the flywheel 3 and the input shaft 4a, the operating range of the engine 1 is maintained at Pel≦Pe≦Pem on the fuel economy curve Fec in FIG. 2.

FIG. 4 shows the relationship of demanded power P1i to the input shaft 4a and revolution speed Ne of the engine 1 in a state in which the engine 1 has initiated driving of the input shaft 4a in the above manner, i.e., in a state of a constant interlocked relationship between the revolution speed Ne in the engine 1 and the revolution speed N1 in the input shaft 4a. In FIG. 4, the horizontal axis indicates demanded power P1i to the input shaft 4a and the vertical axis indicates revolution speed Ne of the engine 1.

Also, in FIG. 4, the characteristic curve segment indicated by the solid line in the range Pel≦P1i≦Pem indicates the relationship, at P1i=Pe on the horizontal axis, of the output power Pe of the engine 1 (horizontal axis) and the revolution speed Ne (vertical axis) with the engine 1 operating on the fuel economy curve Fec of FIG. 2. Specifically, the relationship is such that in the range expressed by Pel≦P1i≦Pem in FIG. 4, when the output power Pe of the engine 1 is any Pec, the revolution speed of the engine 1 is Nec, indicating that the engine 1 is operating on the fuel economy curve Fec. Points Pl and Pm in FIG. 4 correspond to points Pl and Pm in FIG. 2.

Also, as shown by the single-dot and dash line in FIG. 4, in the range 0≦P1i≦Pe1 in FIG. 4 the engine 1 revolution speed Ne is constant at Ne=Nel.

It thus follows that, where the demanded power P1i is less than Pel in FIG. 4, in the following procedure (1), the output power Pe of the engine 1 is constant at Pe=Pel, and the revolution speed Ne of the engine 1 under those circumstances is constant at Ne=Nel.

The relationships of demanded power P1i of the input shaft 4a and revolution speed Ne of the engine 1 in FIG. 4 of the aforementioned relationships are stored in memory in the control device 700.

Using the characteristics as shown in FIG. 4 and obtained from the fuel economy curve Fec, the procedures in the second assessment are as follows.

### [When Pel≦P1i≦Pem]

[Procedure (1)] From the relationship between the demanded power P1i and the revolution speed Ne both stored in control device (FIG. 4), revolution speed Ne=Nec is determined for the engine 1 under conditions in which the output power Pe of the engine 1 is equal to the demanded power P1i at the current time; and
[Procedure (2)] The revolution speed N1=N1ca of the input shaft 4a is determined under assumed conditions in which the engine 1 at demanded revolution speed Nec is driving the input shaft 4a, and the revolution speed N1ca is set as the lower limit revolution speed N1ca in the second assessment.

### [When 0≦P1i≦Pel]

When, in the above Procedure (1), the demanded power P1i is lower than Pel in FIG. 4, as mentioned above, the output power Pe of the engine 1 is set to the constant Pe=Pel, and the revolution speed Ne of the engine 1 under these conditions is set at the constant Ne=Nel.

When the engine 1 begins to supply power Pe to the flywheel 3 and the input shaft 4a, the relationship between the output power Pe of the engine 1 and the demanded power P1i is always P1i<Pe, and the second assessment-making criterion is satisfied as mentioned above.

When the engine 1 begins to supply power Pe to the flywheel 3 and the input shaft 4a, use of only the portion with superior fuel efficiency along the fuel economy curve Fec is always satisfied.

When it is assumed in the above Procedure (2) that the engine 1 is driving the input shaft 4a at the determined revolution speed Nec is, in FIG. 1, it is also assumed that, with the clutch 2 engaged, the engine 1 is driving the input shaft 4a via the drive shaft 1a, the clutch 2, the drive shaft 2a, the transmission 2A, the drive shaft 2b, and the transmission 400A.

In other words, under these assumptions, the relationship between the revolution speed Ne of the drive shaft (engine output shaft) 1a and the revolution speed N1 of the input shaft 4a in FIG. 1 is the constant revolution speed relationship shown below:

Ne=N1/(ie×i2) (10)

Here, “ie” is the transmission gear ratio of the revolution speed of drive shaft 2b divided by the revolution speed of drive shaft 2a, and “i2” is the transmission gear ratio of the revolution speed of input shaft 4a divided by the revolution speed of drive shaft 2b.

Therefore, when the revolution speed N1 of the input shaft 4a is N1=N1ca under the assumption that the engine 1 is driving the input shaft 4a at revolution speed Nec, as mentioned in the above Procedure (2), the relationship between the revolution speed Ne of the engine 1 and the revolution speed N1 of the input shaft 4a under these conditions are added to formula (10) as Ne=Nec and N1=N1ca to obtain the following relationship:

Nec=N1ca/(ie×i2) (10a)

Stated another way, in the above Procedures (1) and (2), the revolution speed of the engine 1 is the value for Nec in formula (10a) and the output power Pe of the engine is Pe=P1i, when the revolution speed N1 of the input shaft 4a is reduced, the engine 1 is restarted when the revolution speed N1 reaches N1ca, the clutch 2 is engaged, and the engine 1 and the input shaft 4a become interlocked.

However, under these conditions, Pe>P1i is true as mentioned above when the demanded power P1i is such that P1i<Pel as shown in FIG. 4.

Here, as a result of the revolution speed N1 of the input shaft 4a reaching N1ca in the second assessment, the engine 1 is restarted, the clutch 2 is engaged, and the engine 1 and the input shaft 4a become interlocked. When, under these conditions, the demanded power P1i is such that P1i≧Pel in FIG. 4, the output power Pe of the engine 1 is Pe=P1i at this time as mentioned above.

As a result, in this situation, the output power Pe of the engine 1 is used as the demanded power P1i for the input shaft 4a. At this time, the engine 1 does not have surplus power to accelerate the rotation of the flywheel 3.

However, immediately after the engine 1 begins to supply power to the flywheel 3 and the input shaft 4a at output power Pe=P1i, the control device increases the throttle angle θ along the fuel economy curve Fec in FIG. 2, the output power Pe from the engine 1 is increased, and the following relationship is established:

Pe≧P1i (11)

In other words, immediately after the engine 1 begins to supply power to the flywheel 3 and the input shaft 4a when Pe=P1i, the relationship in formula (11) is established, the output power Pe from the engine 1 creates surplus power ΔP in excess of the demanded power P1i, and the surplus power ΔP is used to increase the rotation of the flywheel 3.

For this reason, in the above Procedure (1), revolution speed Ne=Nec may be obtained for the engine 1 under conditions in which the output power Pe from the engine 1 is equal to a value in which predetermined power ΔP1i has been added to the demanded power P1i at the time, that is under conditions satisfying Pe=P1i+ΔP1i.

In the above Procedure (1), when Pe=P1i+ΔP1i, surplus power ΔP is generated by the engine 1 once the output power of the engine 1 starts to be supplied to the flywheel 3 and the input shaft 4a.

In other words, in the above Procedure (1), the relationship between the demanded power P1i and the revolution speed Ne of the engine 1 may be established so that, when the revolution speed of the engine 1 is Ne=Nec, the relationship between the output power Pe of the engine 1 and the demanded power P1i remains within the range P1i≦Pe≦P1i+ΔP1i.

In the second assessment, it may be desirable to use the Pe=P1i+ΔP1i setting as mentioned above. This is because there are certain times when the degree to which the accelerator pedal has been depressed by the driver is very small, but then the driver suddenly applies the accelerator pedal to the maximum extent.

In other words, when the degree to which the accelerator pedal has been depressed is very small, the demanded power P1i is also very small, and the lower limit revolution speed N1ca for the input shaft 4a at this time is also small. Thus, when the accelerator pedal is applied suddenly, the demanded power P1i increases sharply, and the lower limit revolution speed N1ca also increases sharply.

As long as the demanded power P1i remains very small, the revolution speed of the input shaft 4a may decreases towards the lower limit revolution speed N1ca, which is a low value corresponding to the small P1i. When the demanded power P1i increases suddenly in this state, the value for the lower limit revolution speed N1ca also becomes a large value. The relationship between the revolution speed N1 of the input shaft which had been decreasing and the increased N1ca is N1<N1ca. The clutch 2 has to be engaged immediately and power Pe from the engine 1 supplied to the input shaft 4a.

However, under conditions in which the revolution speed N1 of the input shaft 4a has already reached a very low revolution speed, when the clutch 2 is engaged, the revolution speed Ne of the engine 1 is also set lower in a constant relationship with the revolution speed of the input shaft 4a.

Stated another way, the revolution speed of the engine 1 when the clutch 2 is engaged is a low revolution speed corresponding to the revolution speed of the input shaft 4a near the lower limit revolution speed N1ca at the point when the demanded power P1i was small. The output power Pe from the engine 1 at this point is the low power at the time when the demanded power P1i was low.

In other words, the relationship between the rapidly increased demanded power P1i and the output power Pe from the engine 1 when the clutch 2 is engaged is P1i>Pe.

In this situation, as already mentioned, the power deficit in P1i−Pe=ΔP can be eliminated by supplying power from a secondary battery. However, when the degree to which the accelerator pedal has been depressed frequently alternates between small and large, the supply of power from a secondary battery is not preferable from the standpoint of efficiency.

Therefore, when the degree to which the accelerator pedal has been depressed by the driver frequently alternates between small and large, the control device can detect this frequency and switch to a decision-making criterion for setting the value of ΔP in Pe=P1i+ΔP1i to a larger value as the criterion for the second assessment.

This concludes the discussion of the second assessment for comparing the size of the power Pe from the engine 1 and the demanded power P1i at various time intervals as the revolution speed of the input shaft 4a decreases.

### [Description of the True Lower Limit Revolution Speed N1c]

Here, an issue arises as to whether the lower limit revolution speed for the input shaft 4a should be set to lower limit revolution speed N1ce or lower limit revolution speed N1ca when the clutch 2 is engaged and the output power of the engine 1 is supplied to the input shaft 4a and the flywheel 3. The issue is studied below.

When the vehicle is operated using only the rotational energy of the flywheel 3, the revolution speed N1 of the input shaft 4a continues to decrease as mentioned above. At the point in time that the output power Pe from the engine 1 begins to be supplied to the continuously decelerating input shaft 4a and flywheel 3, the value of power Pe=Pec from the engine 1 is higher as the revolution speed N1 of the input shaft 4a is high.

For the better understanding the action in which the engine 1 is restarted, and the output power Pe from the engine 1 is supplied to the input shaft 4a and the flywheel 3, the action will be discussed as the following order (1) through (3):
(1) The engine 1 is ignited, and the operation of the engine 1 is matched to the fuel economy curve Fec while the throttle angle θ is increased. As a result, the revolution speed Ne of the engine 1 also increases. At this time, the output power Pe from the engine 1 increases along with the revolution speed Ne of the engine 1, as indicated by Pel≦P1i (=Pe)≦Pem in FIG. 4.

In other words, during operation along the fuel economy curve Fec, the output power Pe from the engine 1 is high output power related to the high revolution speed Ne of the engine 1.
(2) The clutch 2 is engaged when the relationship between the rising Ne and the lower limit revolution speed of the input shaft 4a at the current time matches the relationship shown in formula (10), that is, at the synchronization time for the clutch 2.
(3) Output power Pe from the engine 1 is supplied to the input shaft 4 and the flywheel 3 from the point in time at which the clutch 2 begins to engage.

In the operation (1), a relationship is established where the output power Pe from the engine 1 increases as the revolution speed Ne of the engine 1 increases. In the operation (2), an interlocking relationship is established after the clutch 2 is engaged, in which the revolution speed Ne of the engine 1 and the revolution speed N1 of the input shaft 4a are proportional. In other words, when the revolution speed N1 has a high value, the revolution speed Ne has a correspondingly high value.

Therefore, in the operation (3), at the time when the output power Pe from the engine 1 starts to be supplied to the input shaft or the like, the value of the output power Pe is higher as the revolution speed N1 of the input shaft 4a increases.

As can be seen from the foregoing, the revolution speed of the input shaft 4a at the time output power Pe from the engine 1 begins to be supplied means the true lower limit revolution speed N1c. When focusing on the second assessment-making criterion Pe>P1i, the true lower limit revolution speed N1c may be the higher one of the lower limit revolution speed N1ce or the lower limit revolution speed N1ca. In this manner, the output power Pe from the engine 1 at the synchronization time for the clutch 2 is accordingly Pe≧P1i, and the second assessment-making criterion is satisfied on the safe side.

Even when focusing on the first assessment-making criterion e ec, the higher lower limit revolution speed may be selected from among N1ce in the first assessment-making results and N1ca in the second assessment-making results. In this manner, the speed ratio e for the continuously variable transmission 400 is e≦ec, and the first assessment-making criterion is satisfied.

The reason is that, because the speed ratio e of the continuously variable transmission 400 satisfies the relationship e=N2/N1, the speed ratio e becomes smaller as the revolution speed N1 of the input shaft 4a becomes higher, and the condition of e≦ec is satisfied on the safe side.

The control device compares in magnitude the lower limit revolution speed N1ce obtained in the first assessment and the lower limit revolution speed N1ca obtained in the second assessment. Then, the control device determines higher one of those lower limit revolution speeds as the true lower limit revolution speed N1c for the input shaft 4a.

When the revolution speed N1 of the input shaft 4a decreases and the revolution speed N1 of the input shaft 4a reaches the true lower limit revolution speed N1c, output power from the engine 1 can be supplied to the flywheel 3 and the input shaft 4a as mentioned above.

This concludes the discussion of the true lower limit revolution speed N1c. The description hereunto provided has related to instances where the vehicle is caused to travel solely by the rotational energy of the flywheel 3.

[(b) Powering the Vehicle with Output Power from the Engine 1]

As explained above, when the revolution speed N1 of the input shaft 4a decreases and the revolution speed N1 reaches the lower limit revolution speed N1c, the control device 700 ignites the engine 1, increases the throttle angle θ, and increases the revolution speed Ne of the engine 1.

When the revolution speed of the engine 1 increases, the revolution speed Ne of the engine 1 increases while torque occurs in the engine itself to accelerate the moment of inertia. In this situation, the control device 700 increases the revolution speed Ne of the engine 1 while increasing the throttle angle θ to match the fuel economy curve Fec.

When the revolution speed Ne of the engine 1 increases, the revolution speed Ne of the engine 1 and the revolution speed N1 of the input shaft 4a eventually assume the relationship in formula (10). This is the time when the clutch 2 is synchronized as mentioned above. When the synchronization point has been reached for the clutch 2, the control device engages the clutch 2, and the throttle angle e is increased.

When the clutch 2 is engaged in this manner, a load occurs in the engine 1 that supplies power to the input shaft 4a and increases the rotation of the flywheel 3. Even after the clutch 2 has been engaged in this manner, the control device 700 increases the throttle angle θ to match the fuel economy curve Fec in the manner described above, the output power from the engine 1 is increased, and the revolution speed Ne of the engine 1 is increased.

In other words, subsequent to a state where the output power from the engine 1 at the time of synchronization with the clutch 2 is Pec, the output power Pe from the engine 1 starts to exceed Pec, that is Pe>Pec, after the clutch is engaged.

During the output power Pe from the engine 1 has been increasing in this way, power Pe is supplied from the engine 1 to the input shaft 4a and the flywheel 3.

The relationship of the output power Pe from the engine 1 increased in this manner to the demanded power P1i for the input shaft 4a is Pe>P1i, the surplus power Pe−P1i=ΔP is used to increase the rotation of the flywheel 3.

Because the torque Tf generated in the flywheel 3 due to the surplus power ΔP satisfies the relationship in formula (2), the relationship between the surplus power ΔP and the power (Tf×ωf) generated in the flywheel 3 satisfies the following formula:

ΔP=If×(dωf/dt)×ωf (12)

Here, the relationship between the rotational angular velocity ωf for the flywheel 3 and the rotational angular velocity ω1 for the input shaft 4a is as follows:

ωf=(i1/i2)×ω1 (13)

As a result, the following can be obtained from formula (12).

ΔP=1f×(i1/i2)×(i1/i2)×ω1×(dω1/dt)

This expression can be transformed to obtain the following.

(dω1/dt)=ΔP/[If×(i1/i2)×(i1/i2)×ω1] (14)

The control device (1) uses formula (14) to obtain the rotational angular acceleration (dω1/dt) for the input shaft 4a, and (2) controls the speed ratio e of the continuously variable transmission 400 to match the obtained (dω1/dt). However, this dω1/dt is used to control the speed ratio e on the side in which there is a speed increase for the rotational angular velocity ω1 of the input shaft 4a.

From the relationship in formula (13), the speed increase in (dω/dt) accelerates the flywheel 3 via the transmission 400A and the speed increasing gear 3A.

In other words, if the control device 700 controls the rotational angular acceleration (dω1/dt) of the input shaft 4a by controlling the speed ratio e for the continuously variable transmission 400 so that the relationship in formula (14) holds, real power P1 occurs in the input shaft 4a that corresponds to the demanded power P1i, and the surplus power ΔP=Pe−P1i at this time is used to increase the rotation of the flywheel 3.

The actual power P1 occurring in the input shaft 4a brings torque T1=P1/ω1 occurring in the input shaft 4a. Then, torque T2 occurs in the output shaft 6 according to the relationship in formula (8), and torque T2 drives the driving wheels 6B, 6B via the final reduction gear 6A.

Establishing the relationship in formula (14) by the transmission control of the continuously variable transmission 400 and then generating the torque T1=P1/ω1 in the input shaft 4a bring actual torque T1 occurring in the input shaft 4a corresponding to the signaled torque T1i due to torque control of the continuously variable transmission 400.

While power is being supplied by the engine 1 to the flywheel 3 and the input shaft 4a as mentioned above, the control device 700 increases the throttle angle θ for the engine 1, and increases the revolution speed Ne of the engine 1 along the fuel economy curve Fec.

When the revolution speed Ne of the engine 1 reaches Ne=Neu eventually, the control device 700 stops the operation of the engine 1 and releases the clutch 2.

Operation for driving vehicle in which output power from the engine 1 is supplied to the input shaft or the like has been discussed above.

When operation of the engine 1 has been stopped and thereafter, the vehicle continues to be powered solely by the rotational energy of the flywheel 3.

Thus, as discussed above, the vehicle in FIG. 1 is driven repeatedly by only the rotational energy of the flywheel 3 and by supplying power from the engine 1.

In this embodiment, the maximum revolution speed of the engine 1 during power is supplied from the engine 1 is not set at the revolution speed Nem which corresponds to the maximum power Pem from the engine 1, but Neu which is lower than Nem.

The reason is that if the maximum revolution speed of the engine 1 has been set excessively high, the driver will get a sense that the driving force of the vehicle is much higher than what they want when the degree to which the driver depresses the pedal is small thereby to reduce a value of the demanded power P1i.

Accordingly, in this embodiment, the maximum revolution speed of the engine 1 when power is supplied from the engine 1 is established so as to be proportional to the degree to which the accelerator pedal is depressed.

However, even if the maximum revolution speed of the engine 1 during supply of power by the engine 1 is set at the revolution speed Nem provided when the engine 1 generates the maximum power Pem, there is not any problem in driving vehicle.

### [A First Embodiment of the Continuously Variable Transmission 400 in FIG. 1]

FIG. 5 shows the first embodiment of the continuously variable transmission 400 in FIG. 1 with use of a numeral 401. The components having the same reference numerals as those in FIG. 1 are identical components. The mechanism of the continuously variable transmission 401 in FIG. 5 has been known in Miyao(jp2006-290330).

In FIG. 5, the numeral 7 depicts a control device. Control lines 7a, 7b, 7c, and 7d denoted by a single line include a plurality of power lines and control lines. A reference symbol Acc depicts a signal line for transmitting signals corresponding to an amount of depression of the accelerator pedal. The numeral 7A depicts a storage battery.

Transmissions 2A and 400A shown in FIG. 1 are omitted from the embodiment shown in FIG. 5 thereby to directly connect the drive shaft 2a to input shaft 4a.

In the continuously variable transmission 401, an outer rotor 4A for a generator-motor 4 is interlocked with an input shaft 4a, and an inner rotor 4B of the generator-motor 4 is interlocked with an output shaft 6 via an outlet shaft 4b. A motor-generator 5 is interlocked with the output shaft 6 via a drive shaft 5a and gears 5b and 5c.

Instead of the mechanism shown in FIG. 5, it may be possible to employ a mechanism in which the inner rotor 4B is interlocked to the input shaft 4a, and the outer rotor 4A is interlocked to the outlet shaft 4b.

As a general rule, all of the power generated by the generator-motor 4 is supplied to the motor-generator 5 via the control device 7 except when being charged in the storage battery 7A.

This concludes the discussion of the mechanism shown in FIG. 5.

Operation of the mechanism shown in FIG. 5 will now be described.

The transmission operations performed by the continuously variable transmission 401 in FIG. 5 have been known in Miyao(jp2006-290330). Specifically, when the input shaft 4a is driven against the load of the output shaft 6, relative rotation occurs between the input shaft 4a and the output shaft 6 thereby to cause the generator-motor 4 to generate electricity.

On one hand, operation for generating electricity brings reaction torque in the inner rotor 4B; the reaction torque being generated against electricity-generation torque which is generated in the outer rotor 4A, and is also linked to and caused to rotate by the electricity-generation torque. The reaction torque mechanically drives the output shaft 6 via the outlet shaft 4b.

On the other hand, all of the electric power generated by the generator-motor 4 is, as a general rule, simultaneously supplied to the motor-generator 5 via the control device 7. The motor-generator 5 to which the electric power has been supplied functions as a motor to drive the output shaft 6 via the drive shaft 5a, and gears 5b and 5c.

In this situation, the speed ratio e=N2/N1 of the revolution speed N1 of the input shaft 4a to the revolution speed N2 of the output shaft 6 can be controlled by controlling the amount of electric power generated by the generator-motor 4.

The continuously variable transmission 401 is excellent in efficiency of power transmission when the speed ratio e=N2/N1 is 0≦e≦ec, while deteriorating rapidly in efficiency of power transmission when e>ec. This is well known from formulas (7.41) and (7.42) on p. 226, Hydraulic Engineering, Tomoo Ishihara Ed., Asakura Shoten, (1978).

In FIG. 5, the maximum permissible speed ratio ec is the speed ratio e=N2/N1 when relative rotation between the input shaft 4a and the output shaft 6 is set to zero, that is, ec=1.0.

The speed ratio e used in the embodiment shown in FIG. 5 is intended to be in the range of 0≦e≦ec=1.0, at which excellent efficiency of power transmission is achieved. Also, ec=1.0 is the maximum permissible speed ratio ec for the present invention when the mechanism in FIG. 5 is used.

However, even if e>1.0, the maximum permissible speed ratio may be set within a range of e>1.0 when there may be a range where efficiency of power transmission is relatively high.

The action of setting the startup and departure readiness for the vehicle in FIG. 5 can be performed in the same manner as FIG. 1. However, during the action of setting the startup and departure readiness for the vehicle in FIG. 5, the generator-motor 4 is in an unloaded state so that the output power from the engine 1 is not transmitted to the output shaft 6.

In this state, the control device 7 ignites the engine 1 and increases the throttle angle e of the engine 1 in the same manner as FIG. 1. At this time, the output power of the engine 1 is transmitted to the flywheel 3 via the clutch 2, the drive shaft 2a, and the speed increasing gear 3A. Revolution speed of the flywheel 3 which is received power is raised to the predetermined revolution speed thereby to set the startup and departure readiness for the vehicle.

The action of setting the startup and departure readiness can be performed by use of motor operation of the generator-motor 4 without use of the output power of the engine 1. Specifically, with restraining the output shaft 6 by electrically restraining the motor-generator 5, the generator-motor 4 may function as a motor in using electric power from the storage battery 7A to generate power in the input shaft 4a. The power may be transmitted to the flywheel 3 via the speed increasing gear 3A thereby to rotate the flywheel 3 in the predetermined revolution speed.

The setting of the startup and departure readiness can also be performed using a method in which the engine 1 increases the speed of the flywheel 3 to the predetermined revolution speed while the vehicle is departing under electric vehicle travel (so-called EV travel) using the motor-generator 5.

When the setting of startup and departure readiness has been completed for the vehicle and then the vehicle is driven to travel, actions (a) and (b) below are alternately performed in the same manner as the explain using FIG. 1.
(a) the vehicle is caused to travel under the rotational energy of the flywheel 3 alone, and
(b) the vehicle is caused to travel while the engine 1 supplies power to the flywheel 3 and the input shaft 4a.

In FIG. 1, the actions of (a) and (b) are such that the speed ratio e of the continuously variable transmission 400 is controlled, and the torque T1 from the input shaft 4a is set so that the relationship in formula (7) is satisfied in the case of (a) and formula (14) is satisfied in the case of (b).

On the contrary, in the embodiment shown in FIG. 5, the torque T1 from the input shaft 4a can be set by controlling the torque with the generator-motor 4 in the case of both (a) and (b).

The torque T1 for the input shaft 4a is set by the control device 7 in the same manner as described in FIG. 1. Specifically, the torque T1 is set by performing torque control on the generator-motor 4 so as to match the signaled input torque T1i, which is computed based on the demanded power P1i (=T1i×ω1) for the input shaft 4a and the rotational angular velocity ω1 of the input shaft 4a at that time, and then

When the generator-motor 4 is a direct current motor, torque control of the direct current motor can be performed by current control. Performing the torque control of the direct current motor by current control is known in the art.

In operation (a), during the revolution speed N1 of the flywheel 3 and the input shaft 4a is reduced by consuming only the energy of the flywheel 3 to cause the vehicle to travel, operation for computing the lower limit revolution speed N1ce in the first assessment, and operation for computing the lower limit revolution speed N1ca in the second assessment are similar to those in the explanation using FIG. 1.

Also, in operation (a), using the larger one of computational results N1ce and N1ca as the true lower limit revolution speed N1c for the input shaft 4a is similar to that in the explanation using FIG. 1.

When it has thus been determined that the revolution speed N1 of the input shaft 4a has reached the true lower limit revolution speed N1c, the control device 7 ignites the engine 1, increases the throttle angle θ to increase the revolution speed of the engine 1. Then, the control device 7 engages the clutch 2 once the drive shaft 1a and the drive shaft 2a have been synchronized. These successive operations are similar to those in explanation using FIG. 1.

The clutch 2 may be any one-way clutch commonly known in the art. The reason is that when the revolution speed of the drive shaft 1a is about to exceed the revolution speed of the drive shaft 2a, a one-way clutch makes the drive shaft 1a to rotate integrally with the drive shaft 2a.

Stated the opposite way, a one-way clutch has a functional feature in which the side corresponding to the drive shaft 2a can not drive the side corresponding to the drive shaft 1a to rotate in the same driving direction (that is, the direction of rotation of the engine 1).

More specifically, the side corresponding to the drive shaft 2a cannot drive the side corresponding to the driving shaft 1a in the driving direction, while the side corresponding to the drive shaft 1a can drive the side corresponding to the drive shaft 2a in the same driving direction.

After the clutch 2 has been engaged, the engine 1 operates along the fuel economy curve Fec, and increases in speed. The speed increase of the engine 1, via the drive shaft 1a, the clutch 2, and the drive shaft 2a, increases on one hand the speed of the flywheel 3 via the speed increasing gear 3A, while on the other hand drives the input shaft 4a. The operation is the same as one in explanation using FIG. 1.

Controlling torque of the input shaft 4a to T1 using the generator-motor 4 means controlling the electric power generated by the generator-motor 4.

Controlling the amount of electric power generated by the generator-motor 4 in order to set the torque of the input shaft 4a at T1, and driving and controlling the output shaft 6 by the motor-generator 5 with electric power thus generated also mean controlling the speed ratio e of the input shaft 4a and the output shaft 6.

This means that actual torque T1 equivalent to the signaled torque T1i is generated in the input shaft 4a through torque control accomplished by shifting of the continuously variable transmission 401.

Driving the output shaft 6 by controlling the torque T1 of the input shaft 4a satisfies the relationship in formula (8) in a manner similar to the explanation using FIG. 1. There is also a method in which power is transferred to the generator-motor 4 via a slip ring.

This concludes a description of the device shown in FIG. 5 which is a first embodiment of the continuously variable transmission 400 in FIG. 1.

### [A Second Embodiment of the Continuously Variable Transmission 400 in FIG. 1]

FIG. 6 shows the second embodiment of the continuously variable transmission 400 in FIG. 1 with use of a numeral 402. The components having the same reference numerals as those in FIG. 1 are identical components. Transmissions 2A and 400A shown in FIG. 1 are omitted from the embodiment shown in FIG. 6, in a manner similar to the embodiment shown in FIG. 5, thereby to directly connect the drive shaft 2a to input shaft 4a.

A continuously variable transmission 402 in FIG. 6 is a known continuously variable transmission of an input power split type disclosed in Miyao(jp2006-290330).

The continuously variable transmission 402 includes a differential gear 41. The differential gear 41 includes three shafts, a first of which is interlocked with an input shaft 4a, a second of which is interlocked with a reactive shaft 41f, and a third of which is interlocked with an outlet shaft 4b.

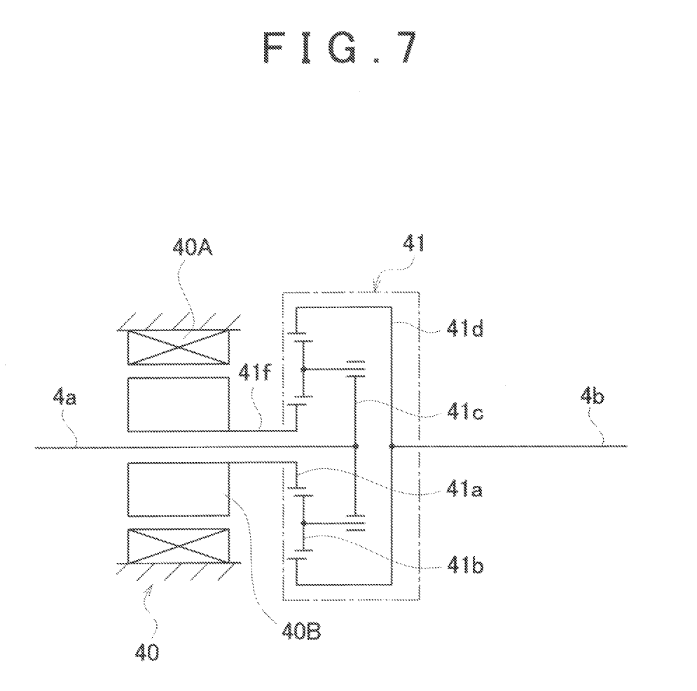

The contents of the differential gear 41 in FIG. 6 are simply expressed as a black box. However, the differential gear 41 specifically includes a mechanism shown in FIG. 7, for example. In FIG. 7, the components denoted by the same reference numerals as those in FIG. 6 are identical components.

As shown in FIG. 7, the differential gear 41 includes a ring gear 41d, a plurality of planetary gears 41b, and a sun gear 41a. The planetary gear 41b is rotatably supported by a carrier 41c. The input shaft 4a is interlocked with the carrier 41c. the planetary gear 41b is engaged with the sun gear 41a and the ring gear 41d. The sun gear 41a is interlocked with a rotor 40B of the generator-motor 40 by way of the reactive shaft 41f. Reference symbol 40A denotes a stator for the generator-motor 40.

The combination of each of the gears of the differential gear 41 is given by way of example. In general, one of the three members of the sun gear 41a, carrier 41c or ring gear 41d is linked to the input shaft 4a, with either of the remaining of these members linked to the outlet shaft 4b, and the last of the remaining members linked to the reactive shaft 41f.

Consequently, in general, the inside of the differential gear 41 shown in FIG. 6 indicated by the single-dot and dash line is represented as a black box. The three members comprising the reactive shaft 41f, the input shaft 4a, and the output shaft 4b are represented in FIG. 6 as elements issuing outwards from the single-dot and dash line.

The differential gear 41 and generator motor 40 constitute a generator motor corresponding to the generator motor 4 in FIG. 5. This is because, in FIG. 6, the relationship between the revolution speed Nr of the generator motor 40, the revolution speed N1 of the input shaft 4a, and the revolution speed N2 of the output shaft 6 (equivalent to the revolution speed of the outlet shaft 4b) are in a constant relationship as indicated by formula (1) in Miyao (JP2006-290330):

er=(e−ec)/(1−ec).

In the formula above, er=Nr/N1, and e=N2/N1, whereas ec is the speed ratio e with the reactive shaft 41f constrained (Nr=0), and ec is a constant value determined in accordance with the mechanism of the differential gear 41.

Specifically, the significance of the above formula is that the revolution speed Nr of the reactive shaft 41f (equivalent to the generator motor 40 revolution speed) is unambiguously determined by the change in the speed ratio e=N2/N1, meaning that the revolution speed Nr of the generator motor 40 is determined according to the relative rotation between the input shaft 4a at revolution speed N1 and the output shaft 6 at revolution speed N2.

Ultimately, comparing FIG. 5 and FIG. 6 indicates that the generator motor 4 in FIG. 5, as described above, carries out a generation action in accordance with the relative rotation of the input shaft 4a and the output shaft 4b, and the generator motor including the differential gear 41 and the generator motor 40 in FIG. 6 also carries out a generating action depending on the relative rotation of the input shaft 4a and the output shaft 4b.

This concludes a description of the mechanisms in FIG. 6 and FIG. 7.

### [Description of the Operation Shown in FIG. 6]

The following is a description of the shifting operation shown in FIG. 6.

The shifting operation of the continuously variable transmission 402 in FIG. 6 is well known in Miyao(JP2006-290330). Specifically, by controlling the electrical generation level at the generator motor 40, the speed ratio e=N2/N1 of the revolution speed N1 at the input shaft 4a and the revolution speed N2 at the output shaft 6 is altered.

In this case, when the input shaft 4a is driven against the load of the output shaft 6, power of the input shaft 4a drives the generator motor 40 via the reactive shaft 41f and the differential gear 41, and the generator motor 40 generates power.

As a result, the generation torque produced at the generator motor 40 mechanically drives the output shaft 6 via the reactive shaft 41f, the differential gear 41, and the outlet shaft 4b. In addition, on the other hand, all of the electrical torque arising in the generator motor 40 is, as a general rule, simultaneously supplied to the motor generator 5 via the control device 7, and motor operation is brought about in the motor generator 5. Thus, the motor generator 5 serving as a motor drives the output shaft 6 via the drive shaft 5a and the gears 5b and 5c.

The speed ratio e=N2/N1 used in shifting in regard to the shifting referred to above in the continuously variable transmission 402 has exceptional efficiency of power transmission at a range of 0≦e≦ec, whereas the efficiency of power transmission deteriorates dramatically when e>ec. This is well known from formulas (7.35) and (7.36) on pp. 220 to 221, Hydraulic Engineering, Tomoo Ishihara Ed., Asakura Shoten (1968).

By ec is meant the speed ratio e=N2/N1 when the rotation of the reactive shaft 41f has been restrained.

Specifically, the speed ratio e used in the mechanism of FIG. 6 of this embodiment is intended to be in the range of 0≦e≦ec, in which the efficiency of power transmission is superior. In addition, ec referred to above in the continuously variable transmission 402 becomes the “maximum permissible speed ratio ec” when the mechanism of FIG. 6 pertaining to the present invention is used. However, if there is a portion where the efficiency of power transmission is relatively high in the range of e>ec, it is possible to set the “maximum permissible speed ratio” in the range of e>ec.

The specific mechanism of the differential gear 41 in FIG. 6 is, in general, preferably the mechanism of FIG. 7, and the value of ec referred to above from a practical standpoint in FIG. 7 becomes a value near 1.4.

This concludes the description of the gear shift operation in FIG. 6.

### [Description of Actions Related to Startup and Departure Readiness for the Vehicle]

The actions related to startup and departure readiness for the vehicle in FIG. 6 can be carried out in a manner similar to FIG. 1. However, when setting the startup and departure readiness for the vehicle in FIG. 6, the generator motor 40 is placed in an unloaded state in order that the output power of the engine 1 is not transmitted to the output shaft 6. The reasoning is that when the input shaft 4a is driven and the generator motor 40 becomes unloaded, the reactive shaft 41f rotates freely from the disposition of the differential gear, and the power of the input shaft 4a is not transferred to the output shaft 6.

With the generator motor 40 in an unloaded state, when setting the startup and departure readiness for the vehicle, the control device 7 ignites the engine 1 and increases the throttle angle e of the engine 1 in the same manner as was described in relation to FIG. 1. As a result, the output power of the engine 1 increases until the flywheel 3 reaches the predetermined revolution speed described above via the drive shaft 1a, the clutch 2, the drive shaft 2a, and the speed increasing gear 3A.

The startup and departure readiness for the vehicle of the vehicle described above can be set, in the same manner as in the embodiment shown in FIG. 5, using the motor generator 5 without using the output power from the engine 1. Specifically, the motor generator 5 can be electrically restrained without using the output power from the engine 1, thereby restraining the output shaft 6. Using the electrical power of the storage battery device 7A, motor operation is brought about in the generator motor 40, and the motor operation is transmitted to the flywheel 3 via the reactive shaft 41f, the differential gear 41, the input shaft 4a, and the speed increasing gear 3A. As a result, the flywheel 3 can be set at the prescribed revolution speed.

As cited in reference to FIG. 5 above, setting the startup and departure readiness for the vehicle in FIG. 6 can also be achieved by a method in which the engine 1 increases the flywheel 3 to a prescribed revolution speed during vehicle departure by EV travel using the motor generator 5.

This concludes description of the actions associated with startup and departure readiness for the vehicle in FIG. 6.

### [Causing the Vehicle to Travel Using Only the Rotational Energy of the Flywheel 3 of the Vehicle in FIG. 6]

When the departure readiness of the vehicle has been completed and the vehicle is caused to travel, as in FIG. 1, the vehicle initially travels merely due to the rotational energy of the flywheel 3. In this case, the command value designated by accelerator pedal depression, as in FIG. 1, becomes the demanded power P1i (kW) to the input shaft 4a.

When the demanded power P1i is designated for the input shaft 4a, the control device 7 computes the signaled torque T1i for the input shaft 4a from the relationship P1i=T1i×ω1 by detecting the rotational angular velocity ω1 of the input shaft 4a in the same manner as in the embodiment shown in FIG. 5.

In FIG. 6, the relationship between the torque T1 of the input shaft 4a, the torque T2 of the output shaft 6, and the torque Tr of the reactive shaft 41f is well known from Miyao (JP2006-290330). Specifically, Miyao discloses the following relational formulas in formulas (12) and (13):

T2=(T1d/ec)×[{ηmo−(ηmr×ηe)}+{(ec/e)×ηmr×ηe}]

Trd=(ec−1)×T2×ηmr/[{ηmo−(ηmr×ηe)}+{(ec/e)×ηmr×ηe}]

In the two formulas above, “T1d” and “Trd” are the torque T1 of the input shaft 4a in FIG. 6 of this specification, and the torque Tr of the reactive shaft 41f, and “ηmo” is the mechanical efficiency of power transmission from the input shaft 4a through the differential gear 41 to the outlet shaft 4b. “ηmr” is the mechanical efficiency of power transmission from the input shaft 4a through the differential gear 41 to the reactive shaft 41f.

In the two formulas above, “ηe” is the efficiency of power transmission from the motor generator 5 up to driving the output shaft 6 via the drive shaft 5a and the gears 5b, 5c when the power in the reactive shaft 41f carries out a charging operation at the generator motor 40, with this generated power causing motor operation of the motor generator 5.

In addition, “T2”, “ec” and “e” in the two formulas above are the same as the aforementioned torque T2, the maximum permissible speed ratio ec, and the speed ratio e in regard to FIG. 6.

From the above two formulas in Miyao(JP2006-290330), the relationship between the aforementioned signaled torque T1i for the input shaft 4a and the signaled torque Tri for the reactive shaft 41 arising from this signaled torque T1i becomes:

Tri={(ec−1)/ec}×ηmr×T1i (16)

Specifically, in the embodiment of FIG. 6, when the demanded power P1i (kW) for the input shaft 4a is designated by depressing of the accelerator pedal, the control device 7 computes the signaled torque T1i as described above, the signaled torque T1i is used, and the signaled torque In at the reactionary shaft 41f is computed by the relationship of formula (16).

As a result, the control device 7 generates torque at the reactive shaft 41f corresponding to the computed signaled torque In at the generator motor 40. In other words, the control device 7 performs power generation at the generator motor 40, producing torque control by which the power generation generates a load torque Tr at the reactive shaft 41f. Torque control of the torque Tr, as described above, is carried out by current control at the generator motor 40. In this manner, generation of torque Tr at the reactive shaft 41f by the control device 7 generates torque T1 on the input shaft 4a based on the relationship of formula (16).

When torque T1 is generated on the input shaft 4a in this manner, as in FIG. 1, torque T2 is generated on the output shaft 6 based on the relationship of formula (8) or of formula (12) in Miyao (JP2006-290330), allowing driving of the vehicle.

During operation of the vehicle, the operator changes the level to which the accelerator pedal is depressed.

Continual change of the level to which the accelerator pedal is depressed by the operator is thus the same as changing the signaled torque T1i on the input shaft 4a. This results in the control device 7 changing the torque Tr of the reactive shaft 41f based on formula (16) in accordance with the change in the level to which the accelerator pedal is depressed, specifically, changing the generation level of the generator motor 40.

As can be understood from the description above, changing the generation level of the generator motor 40 results in the motor generator 5 controlling the revolution speed N2 of the output shaft 6, resulting in control of the speed ratio e=N2/N1.

This means that the actual torque T1 corresponding to the signaled torque T1i is generated in the input shaft 4a as a result of torque control depending on the shifting of the continuously variable transmission 402.

As described above, generation of actual torque T1 in the input shaft 4a means that load torque of torque Tf is generated in the flywheel 3 via the input shaft 4a and the accelerator 3a.

This load torque Tf, in the relationship of formula (2), changes the angular revolution speed dωf/dt of the flywheel 3 to a negative value, and the revolution speed Nf of the flywheel 3 continues to decelerate. This also causes deceleration of the revolution speed N1 of the input shaft 4a linked to the flywheel 3.

This also means that rotational energy of the flywheel 3 is consumed, generating torque T1 on the input shaft 4a.

When the revolution speed N1 of the flywheel 3 and the input shaft 4a continue to decrease as a result of the energy of the flywheel 3 alone being consumed in order to cause the vehicle to travel, the operation for computing the lower limit revolution speed N1ce according to the first assessment in the description relating to FIG. 1 and the lower limit revolution speed N1ca in accordance with the second assessment is the same as described in relation to FIG. 1.

In addition, the computation in which the larger of the computed values for N1ce and N1ca is taken as “true lower limit revolution speed N1c” at the input shaft 4a is also the same as for FIG. 1.

This concludes the description of causing the vehicle in FIG. 6 to travel based only on the rotational energy of the flywheel 3.

[Vehicle Traveling when Driven by the Engine 1 in FIG. 6]

When the revolution speed N1 of the input shaft 4a is taken as having reached the “true lower limit revolution speed N1c”, the control device 7, as in FIG. 1, ignites the engine 1 and continues to increase the throttle angle e, thereby increasing the revolution speed of the engine 1. The drive shaft 1a and the drive shaft 2a engage the clutch 2 when they are at the same rotational rate. This sequence of operations is also the same as described in relation to FIG. 1.

After the clutch 2 has been engaged in this manner, the engine 1 increases in speed while operating along the fuel economy curve Fec (FIG. 2). The accelerating of the engine 1 acts via the drive shaft 1a, the clutch 2, and the drive shaft 2a to accelerate the flywheel 3, on the one hand, via the speed increasing gear 3A, and to drive the input shaft 4a, on the other hand. This operation is also the same as described in relation to FIG. 1.

When carrying out this operation, the operator signals the demanded power P1i (kW) to the input shaft 4a by depressing the accelerator pedal, and the control device 7 detects the current rotational angular velocity ω1 at the input shaft 4a and computes the signaled torque T1i for the input shaft 4a based on the relationship P1i=T1i×ω1. This operation is the same as in FIG. 1 and FIG. 5.

The control device 7 computes the signaled torque Tri for the reactive shaft 41f by substituting the signaled torque T1i into formula (16). Next, the control device 7 controls the generation level of the generator motor 40 in a state whereby the load of torque Tr=Tri is produced on the reactive shaft 41f.

Electrical generation control of the generator motor 40 in this manner produces an actual load torque Tr on the reactive shaft 41f, which causes “actual torque T1” in accordance with the designation by the acceleration pedal to be generated on the input shaft 4a based on the relationship of formula (16).

Control of the actual torque of the input shaft 4a at T1 by the generator motor 40 refers to control of the generated electrical power by the generator motor 40, and all of the electrical power generated by the generator motor 40 is, as a general rule, applied to the motor generator 5. The motor generator 5 drives the output shaft 6 via the drive shaft 5a and the gears 5b and 5c.

The electrical generation level at the generator motor 40 is controlled in order to set the actual torque T1 of the input shaft 4a. Execution of drive and control of the output shaft 6 by the motor generator 5 in this manner means that the speed ratio e between the input shaft 4a and the output shaft 6 is controlled.

This amounts to generating actual torque T1 corresponding to the signaled torque T1i at the input shaft 4a by torque control in accordance with shifting of the continuously variable transmission 402.

In this case, torque control of the generator motor 40 by the control device 7 is the same as control in the case where the vehicle of FIG. 5 is caused to travel by the rotational energy of the flywheel 3.

In addition, controlling the actual torque T1 of the input shaft 4a amounts to driving the output shaft 6 in accordance with formula (12) in Miyao (JP2006-290330) or the relationship of formula (8), in the same manner as described in relation to in FIG. 1.

This concludes the description of causing the vehicle to travel during driving of the engine 1 in FIG. 6.

The motor generator 5 in FIG. 5 and FIG. 6 is linked to the drive wheel 6B via the output shaft 6. Specifically, the motor generator 5 drives the drive wheel 6B along with the output shaft 6. Consequently, either the front wheels or rear wheels of the vehicle can be driven by the output shaft 6, and the remaining wheels on the other side can be driven by the motor generator 5.

The vehicle is caused to travel by alternately carrying out (a) the operation involving driving of the input shaft 4a using only the rotational energy of the flywheel 3 and (b) the operation involving accelerating rotation of the flywheel 3 and driving the input shaft 4a using the engine 1.

Alternately carrying out the operations of (a) and (b) is the same as described in relation to FIG. 1 and FIG. 5 above.

This concludes a description of all of the operations in FIG. 6.

### [Approach Involving Purely Electrical Driving of the Continuously Variable Transmission 400]

In the continuously variable transmissions 401, 402 in FIGS. 5 and 6, some of the power in the input shaft 4a is mechanically transmitted to the output shaft 6 via the outlet shaft 4b, whereas the remainder of the power of the input shaft 4a becomes electrical power at the generator motor 4 or generator motor 40. The split electrical power again becomes mechanical power at the motor generator 5 and is supplied to the output shaft 6. This type of mechanism is known as a power-split continuously variable transmission.

In contrast, the continuously variable transmission 400 in FIG. 1 may be a continuously variable transmission having a format in which the power at the input shaft 4a is all converted to electric power, and the drive wheel 6B is driven purely electrically. With this type of purely electrically driven format, for example, all of the mechanical power of the input shaft 4a is converted to electric power by the generator motor, and all of the electric power that has been converted brings about motor operation at the motor generator, with this motor operation driving the drive wheels 6B, 6B.

With purely electric driving, as shown in FIG. 5, the generator motor can torque-control the input shaft 4a; therefore, the demanded power P1i prescribed by depressing of the acceleration pedal is converted to the signaled torque T1i at the input shaft 4a, and actual torque T1=T1i can be generated at the input shaft 4a by torque control at the generator motor.

Consequently, the purely electrically driven continuously variable transmission only has an altered continuously variable transmission format. As in the embodiments shown in FIG. 5 and FIG. 6, the two operations (a) and (b) described above, specifically, the operation (a) in which the input shaft 4a is driven by the rotational energy of the flywheel 3 alone, and the operation (b) in which the engine 1 supplements power for the flywheel 3 and the input shaft 4a, can be carried out alternately. Moreover, the first assessment in which N1ce referred to above is determined and the second assessment in which N1ca is determined in operation (a) are both possible.

The above represents an approach for operating the continuously variable transmission 400 by purely electrical driving.

In addition, although outside the main point of the present invention, startup and departure readiness of the vehicle in the above embodiments is not absolutely necessary.

Specifically, as when an ordinary vehicle departs, the start switch is turned on, the engine 1 is operated, and the accelerator pedal is depressed, causing the vehicle to depart.

Given that the speed ratio e=N2/N1 of the continuously variable transmission 400, 401, or 402 is set to zero with the vehicle in a pre-departure state, when the clutch 2 is engaged as the throttle angle θ is increased from start-up of the engine 1 by turning on the start-up switch, the power Pe of the engine 1 accelerates the flywheel 3 via the clutch 2, the drive shaft 2a, and the speed increasing gear 3A.

As the flywheel 3 is thus accelerated by the power Pe of the engine 1, the actual torque T1 corresponding to the signaled torque T1i on the input shaft 4a may be set by torque control in accordance with the continuously variable transmission 400, 401, or 402.

In addition, in this case, torque control becomes control of the speed ratio e at the continuously variable transmission 400, 401, or 402 as described above, and thus the vehicle departs based on the relationship of formula (8) as a result of this increase in the speed ratio.

However, in this case, at the stage at which the flywheel 3 begins to increase towards the prescribed revolution speed in this manner, when the accelerator pedal is suddenly depressed by a large amount, the demanded power P1i rapidly increases, while the output power of the engine 1 cannot increase rapidly, on the other hand. The reason that the output power of the engine 1 cannot increase rapidly is that load generates in the engine 1 to accelerate the flywheel 3.

Because the above condition arises, the relationship between the output power Pe of the engine 1 and the increased demanded power P1i becomes Pe<P1i a short period of time immediately after the accelerator pedal has been suddenly depressed. As a result, there is insufficient power for driving the input shaft 4a or for accelerating the flywheel 3 at the time of acceleration when the vehicle makes a sudden departure in this manner. Problems arise with loss of vehicle acceleration capacity.

In order to resolve this problem, in the configuration shown in FIG. 1, the motor generator is provided on the drive shaft 2a, and the insufficient power can be compensated for by this motor generator with the electrical power from the storage cell device. In addition, in the configurations of FIG. 5 and FIG. 6, the insufficient power can be compensated for by supplementing auxiliary electrical power from the storage battery device 7A to the motor generator 5.

As described above, during the time when the vehicle starts up and departs as a result of the input shaft 4a being driven while the engine 1 increases the revolution speed of the flywheel 3, when the flywheel 3 reaches the predetermined revolution speed, operation of the engine 1 is stopped, and subsequently, the vehicle may begin traveling using only the rotational energy of the flywheel 3.

In the embodiments in FIGS. 1, 5, and 6, the clutch 2 is not necessarily required. Specifically, when the engine 1 drives the flywheel 3, as shall be apparent, the clutch 2 is not required, and the drive shaft 1a and the drive shaft 2a may be directly connected. More specifically, when the fuel supply to the engine 1 is stopped and power is taken off to the output shaft 6 from the rotational energy of the flywheel 3 alone, then even if the drive shaft 1a and the drive shaft 2a are directly connected, it will merely be that the engine 1 is driven from the drive shaft 2a, so that the control described above can still be performed.

However, in the above embodiment, when fuel supply to the engine 1 is stopped and power is taken off to the output shaft 6 from the rotational energy of the flywheel 3 alone, if the clutch 2 is eliminated, and the drive shaft 1a and the drive shaft 2a are directly connected, then the engine 1 will rotate along with the drive shaft 2a, and torque load on the engine 1 will arise due to this rotation.

In the above embodiment, signaling of the requested vehicle power P1i for the input shaft 4a is performed by depressing the accelerator pedal. However, signaling of the demanded power may also be carried out with respect to the output shaft 6. This is because the actual power P1 of the input shaft 4a and the actual power P2 of the output shaft 6 have the following relationship, with η being the efficiency of power transmission of the continuously variable transmission 400:

P1×η=P2 (17)

Specifically, when the signaling for demanded power relates to demanded power P2i for the output shaft 6, then the requested output P1i for the input shaft 4a can be computed from the demanded power P2i using the relationship of formula (17), and control can be carried out using this computed demanded power P1i. In other words, the level to which the accelerator pedal is depressed may be related to a signaling for the demanded power P1i for the power train from the input shaft 4a to the output shaft 6.

The efficiency of power transmission η used in the computation of formula (17) changes in accordance with the operating conditions of the continuously variable transmission 400. The value of the efficiency of power transmission η can be determined theoretically or experimentally.

In addition, “η” in formula (17) may be a constant. For example, assuming η=1.0, the formula (17) becomes P1=P2.

However, the actual efficiency of power transmission changes depending on the operating conditions; therefore, in attempting to set η at a constant value of 1.0, when the demanded power P2i for the output shaft 6 has been signaled, a discrepancy arises between the power P1 of the input shaft 4a and the power P2 of the output shaft 6, as can be seen from formula (17).

However, no problems arise even if P1i including the discrepancy is determined from P2i using 1.0 for η in formula (17), and this P1i value is used in order to specify the vehicle travel energy. The reasoning is that the depressing of the accelerator pedal by the operator to set the travel speed of the vehicle does not mean that the vehicle travel power is set at a specific constant value. If the travel speed when the operator depresses the accelerator pedal by a certain amount is smaller than the value expected by the operator, then the operator can adjust the travel speed by additionally depressing the accelerator pedal. Conversely, if the operator feels the travel speed to be too great, then they can ease off the accelerator pedal.

Consequently, there are no problems from a practical standpoint, even if formula (17) is altered so that P1=P2.

It is sometimes favorable for the demanded power to be requested for the output shaft 6 in this manner. Such is the case when, as shown in FIG. 5 and FIG. 6, so-called EV travel is selected, specifically, when the motor generator 5 is driven using energy solely from the electrical power stored in the battery 7A, and only the motor generator 5 drives the output shaft 6.

With EV travel, the control device 7 does not control the power P1 of the input shaft 4a but the power P2 of the output shaft 6, and it is convenient from the standpoint of the control device 7 for the level to which the accelerator pedal is depressed to signal the demanded power P2i for the output shaft 6.

With EV travel, control device 7 carries out control of vehicle travel using only energy from the electrical power of the battery 7A, and not a control for alternately causing (a) the vehicle to travel due to the rotational energy of the flywheel 3 alone and (b) the vehicle to travel while both the flywheel 3 and input shaft 4a are driven by the engine 1.

In the embodiments described above, the fuel economy curve Fec (refer to FIG. 2) can be substituted for the other “control line” in the relationship whereby the output power of the engine 1 increases along with an increase in the revolution speed of the engine 1.

For example, in the engine 1, the control line can be used for the relationship whereby the relationship between the throttle angle θ and the revolution speed Ne produces minimum generation of NOₓ, CO, and the like.

Specifically, control of the engine 1 can be carried out by operating the engine 1 on the new control line instead of operating the engine 1 on the fuel economy curve Fec.

In addition, there may be a plurality of control lines. In this case, one of the plurality of control lines should be selected as being appropriate for each individual state in which the vehicle travels.

A gasoline engine is depicted as the engine 1 in the above embodiments, but the engine 1 can be any other heat engine such as a diesel engine or gasoline turbine. The reasoning is that heat engines ordinarily have a wide operating rotation range, and within this wide operating rotation range, there is definitely a fuel economy curve that produces favorable fuel consumption or a “control line” at which NOₓ and the like are a minimum. Thus, when the heat engine is supplying rotational energy to the flywheel 3 and the input shaft 4a, the control device can carry out control so that the heat engine is operating within a desirable range on the fuel economy curve or on the “control line.”

When a heat engine other than a gasoline engine is used as the engine 1, control of the output power of the heat engine is carried out by control of the amount of fuel supplied to the heat engine, correspondingly with respect to control of the throttle angle e in the gasoline engine 1.

### [Potential for Industrial Use]

The method for controlling energy buffer driving pertaining to the present invention is suitable not only for automobiles as in the above description, but in power trains used in work machinery, agricultural machinery, locomotives for rolling stock, watercraft, a variety of other types of applications; as well as in power trains that operate with variable load power.

What is claimed is:

1. A method for controlling an energy buffer drive, comprising:
a heat engine interlocking with a flywheel and an input shaft, and the input shaft interlocking with driving wheels of a vehicle via a continuously variable transmission and an output shaft;
the heat engine having a control line Fec describing a relationship whereby output power rises in tandem with a rise in revolution speed in the heat engine, and the heat engine operates on the control line according to control of supplied fuel;
driving of the vehicle following a relationship whereby demanded power P1i to the power train extending from the input shaft to the output shaft is signaled by the degree to which an accelerator pedal is depressed when the accelerator pedal is depressed;
storing a relationship between output power Pe and revolution speed Ne on the control line Fec in the heat engine in memory in a control device;
having the control device control, in alternating fashion
(a) an action whereby rotational energy of the flywheel alone is the power supply source to the input shaft, and
(b) an action whereby the heat engine is the power supply source to the input shaft while operating on the control line Fec and accelerating rotation of the flywheel;
the control according to a) or b) being accomplished through a control wherein, using the relationship T1i=P1iω1, signaled torque T1i in the input shaft is computed from the demanded power P1i and rotational angular velocity ω1 at a current time in the input shaft, actual torque T1 equivalent to the signaled torque T1i is generated in the input shaft through torque control accomplished by shifting of the continuously variable transmission, and the shifting in the continuously variable transmission converts the resulting actual torque T1 to a torque T2 of the output shaft, which converted torque T2 drives the driving wheels; and
in a control with the revolution speed N1 of the input shaft in continuous decline through control of the control device carrying out the function of a),
having the control device
by way of a first assessment, calculate one lower limit revolution speed N1ce from the relationship N1ce=N2/ec, where N2 is revolution speed in the output shaft at the current point in time and ec is the maximum permissible speed ratio of the speed ratio e=N2/N1 in the continuously variable transmission;
by way of a second assessment, and on the basis of the relationship of revolution speed Ne and output power Pe in the heat engine on the control line Fec, calculate a revolution speed Ne=Nec of the heat engine under circumstances in which output power Pe in the heat engine equals the value of the demanded power P1i at the current point in time or a value equal to the demanded power P1i at the current point in time plus a prescribed power ΔP1i, calculate revolution speed N1ca in the input shaft on the assumption that the input shaft is being driven by the heat engine at the calculated revolution speed Nec, and compute N1ca as another lower limit revolution speed N1ca in the input shaft;
designate the larger of the values of the N1ce and N1ca as the true lower limit revolution speed N1c; and
when the revolution speed N1 continues to decline and the revolution speed N1 reaches the true lower limit revolution speed N1c, restart the heat engine, and begin to resupply power of the heat engine to the flywheel and to the input shaft.

2. The method of controlling an energy buffer drive according to claim 1, comprising the continuously variable transmission having a mechanism configured using a generator-motor adapted to generate electricity through relative rotation of an input shaft and an output shaft, and a motor-generator interlocked with the output shaft; and, as a rule, all of the electrical power generated in the generator-motor being supplied to the motor-generator.

3. The method of controlling an energy buffer drive according to claim 1, comprising the continuously variable transmission having a mechanism wherein, of three shafts in a differential gear, one shaft interlocks with an input shaft, another shaft interlocks with an output shaft, and a final remaining shaft interlocks with a generator-motor via a reactive shaft; a motor-generator interlocks with the output shaft; and, as a general rule, all of the electrical power generated in the generator-motor is supplied to the motor-generator.

4. The method of controlling an energy buffer drive according to claim 1 comprising the control line Fec being both a characteristic curve that describes optimal consumed fuel mass in the heat engine per unit time for each of any individual output power levels at which the heat engine operates at constant output power, and a fuel economy curve Fec that describes increasing revolution speed Ne and output power Pe in the heat engine in association with increasing fuel feed to the heat engine.

5. The method of controlling an energy buffer drive according to claim 2 comprising the control line Fec being both a characteristic curve that describes optimal consumed fuel mass in the heat engine per unit time for each of any individual output power levels at which the heat engine operates at constant output power, and a fuel economy curve Fec that describes increasing revolution speed Ne and output power Pe in the heat engine in association with increasing fuel feed to the heat engine.

6. The method of controlling an energy buffer drive according to claim 3 comprising the control line Fec being both a characteristic curve that describes optimal consumed fuel mass in the heat engine per unit time for each of any individual output power levels at which the heat engine operates at constant output power, and a fuel economy curve Fec that describes increasing revolution speed Ne and output power Pe in the heat engine in association with increasing fuel feed to the heat engine.
